(19) United States
(12) Patent Application Publication
(10) Pub. No.: US 2009/0009694 A1
(43) Pub. Date: Jan. 8, 2009

(54) Color Filter, Process For Manufacturing Color Filter, And Liquid Crystal Display Device

(75) Inventors: Hideaki Ito, Shizuoka (JP); Hideyuki Nakamura, Shizuoka (JP); Mitsutoshi Tanaka, Shizuoka (JP); Haruhiko Yoshino, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/664,921

(22) PCT Filed: Oct. 7, 2005
(86) PCT No.: PCT/JP05/18898

§ 371 Date: Apr. 9, 2007

(30) Foreign Application Priority Data
Oct. 8, 2004 (JP) 2004-296385
Mar. 2, 2005 (JP) 2005-058015

(51) Int. Cl. G02F 1/1335; G02B 5/22; B05D 5/06; B32B 37/14

(52) U.S. Cl. 349/96; 359/891; 427/64; 156/230

(57) ABSTRACT

A color filter including colored pixels of at least two or more colors, in which the colored pixels contain at least pigment particles, the contrast of each colored pixel is not lower than 2000 and the difference between the contrast of the colored pixel having the lowest contrast and the contrast of the colored pixel having the highest contrast among the colored pixels of two or more colors is not more than 600; a process for manufacturing the same; and a liquid crystal display device using the color filter.

### TECHNICAL FIELD

The present invention relates to a color filter, which is preferably used in large screen equipment such as notebook computers or television monitors, and a process for manufacturing the same, as well as a liquid crystal display device using the color filter.

### BACKGROUND ART

A color filter is a component pale indispensable for a liquid crystal display (hereinafter, also referred to as “liquid crystal display device”). A liquid crystal display device is very compact, has performance equivalent or superior to that of a conventional CRT display, and is coming to replace CRT displays.

For forming a color image of a liquid crystal display device, light passed through a color filter is colored to the color of each pixel constituting the color filter, and light of these colors is combined to form a color image. Currently, pixels of the three colors of RGB form a color image. As a material constituting a color filter, due to the requirements of heat resistance and light resistance, a material in which an organic pigment is dispersed in a resin such as acryl is mainly used. However, due to use of an organic pigment, in such a color filter, depolarization, the so-called depolarization effect, is generated due to light scattering of pigment particles, and this leads to a decrease in contrast.

In recent years, as liquid display devices are used for TVs and monitors, the demand for display quality has become strict. In particular, improvement in the color reproductivity range, and improvement in the contrast of a liquid display device are essential conditions. In a conventional color filter (see, for example, Japanese Patent Application Laid-Open (JP-A) No. 2001-194658), the contrast is about 800 to 1500 due to depolarization, and it is difficult to say that sufficient contrast property is attained.

Further, if the contrast of a whole color filter is high, since when the balance of the contrast of each pixel of RGB is different, the amount of light leaked from each pixel of RGB is different, when, for example, the amount of light leaked from a B pixel is large, a problem also arises that the chromaticity of a liquid crystal display device at black display is shifted from an achromatic color point to a bluish direction. Even if the contrast of a color filter is high, when the contrast of a polarizing plate is low, the contrast of the liquid crystal display device remains low and, further, even if the contrast of the polarizing plate is high, when the crossed transmittance of the polarizing plate is high at around 400 nm, a problem also arises that the chromaticity of a liquid crystal display device at black display is shifted from an achromatic color point to a bluish direction.

### DISCLOSURE OF INVENTION

In view of the aforementioned circumstances, the present invention has been made, and provides a color filter in which the contrast of each pixel is high, a vivid image is displayed, the contrast of each pixel of RGB is balanced, and black display property is excellent, a process for manufacturing, the same, and a liquid crystal display device having this color filter. Also, the invention provides a liquid display device which displays a vivid image having a high contrast, in which the contrast of each pixel of RGB is balanced, and which is excellent in black displaying property, by combining a pixel having a high contrast and a polarizing plate having a high contrast.

A first aspect of the invention provides a color filter comprising colored pixels of two or more colors, wherein each of the colored pixels contains at least pigment particles, the contrast of each of the colored pixels is not lower than 2000, and the difference between the contrast of a colored pixel having the lowest contrast and the contrast of a colored pixel having the highest contrast among the colored pixels of two or more colors is not more than 600.

A second aspect of the invention provides a process for manufacturing the color filter of the first aspect, comprising forming a resin layer from a colored photosensitive resin composition containing (1) an alkali-soluble resin, (2) a monomer or an oligomer, (3) a photopolymerization initiator or a photopolymerization initiator system, and (4) pigment particles.

A third aspect of the invention provides a liquid crystal display device, which comprises a color filter of the first aspect.

A fourth aspect of the invention provides a liquid crystal display device comprising a backlight, a polarizing plate, at least two substrates, a liquid crystal layer supported by the substrates, an electrode provided on at least one part of the substrates, and a color filter layer provided on at least one part of the substrates, wherein the color filter layer is a color filter of the first aspect, and the polarizing plate has a polarization degree of 99.95 or higher, and an crossed transmittance at 400 in of 0.05% or lower.

### BRIEF DESCRIPTION OF DRAWINGS

FIG. 1 is a schematic cross-sectional view showing one example of the liquid crystal display device of the present invention.

FIG. 2 is a cross-sectional vie-w showing another example of the liquid crystal display device of the invention.

FIG. 3 is a schematic cross-sectional view showing still another example of the liquid crystal display device of the invention.

### BEST MODE FOR CARRYING OUT THE INVENTION

First, the color filter layer of the present invention (hereinafter, simply referred to as “color filter” in some cases) will be explained and, then, a process for manufacturing a color filter, and a liquid crystal display device: will be successively described.

### <Color Filter Layer>

A color filter layer of the invention is a color filter having colored pixels of two or more colors. Each of the colored pixels contains at least pigment particles. The contrast of each colored pixel is not lower than 2000, and a difference between the contrast of a colored pixel having the lowest contrast and the contrast of a colored pixel having the highest contrast among the colored pixels of two or more: colors is not more than 600.

### <Contrast>

The contrast of each colored pixel of the color filter of the invention is not lower than 2000, more preferably not lower than 2800, further preferably not lower than 3000, most preferably not lower than 3400. If the contrast of each colored pixel constituting the color filter is less than 2000, when an image of a liquid crystal display device having such a color filter is observed, the image observed is whitish as a whole, and it is difficult to see it, and this is not preferable. In addition, the difference between the contrast of a colored pixel having the lowest contrast, and the contrast of a colored pixel having the highest contrast is not higher than 600, more preferably not higher than 410, further preferably not higher than 350, most preferably not higher than 200. When the difference between the contrast of the colored pixel having the lowest contrast, and the contrast of the colored pixel having the highest contrast exceeds 600, since an amount of light leaked from each colored pixel part at black display is greatly different, even when a color is regulated based on color property at white display of a liquid crystal display device, phenomenon of disintegration of color balance occurs in black display, color reproducibility is deteriorated, and this is not preferable.

The contrast means the contrast of each pixel of R (red), G (green) and B (blue) constituting a color filter, which is assessed according to the respective colors.

A method measuring a contrast is as follows: A polarizing plate is overlaid on both sides of a subject to be measured, polarization directions of polarizing plates are made to be parallel with each other and, in this state, backlight is applied from a side of one of polarizing plates, and a luminance Y1 of light passed through the other polarizing plate is measured. Then, in the state where polarizing plates are crossed, backlight is applied from a side of one of polarizing plates, and a luminance Y2 of light passed through other polarizing plate is measured. Using the resulting measured values, a contrast is calculated as Y1/Y2. Herein, as a polarizing plate, G1220DUN manufactured by Nitto Denko can be used and, as a measuring instrument, a color luminance meter (trade name: BM-5, manufactured by Topcon) can be used. The polarizing plate used in measuring a contrast is the same as a polarizing plate used in a liquid crystal display device, which uses the color filter.

### <Colored Pixel>

A colored pixel of the color filter of the invention is formed from a colored resin composition. It is preferable that at least one color of a colored pixel forming the color filter of the invention contains, as a colorant, C.I.Pigment•Red 254, or C.I.Pigment•Green 36 or C.I.Pigment•Blue 15:6. By inclusion of these colorants, a color filter having a high contrast can be manufactured.

### (Colorant)

In the invention, a preferable colorant is C.I.Pigment•Red 254 in (i) a R (Red) colored resin composition, C.I.Pigment•Green 36 in (ii) a G (Green) colored resin composition, and C.I.Pigment•Blue 15:6 in (iii) a B (Blue) colored resin composition.

A content of C.I.Pigment•Red 254 in the (i) is preferably 0.80 to 0.96 g/m², more preferably 0.82 to 0.94 g/m², particularly preferably 0.84 to 0.92 g/m² in a dry film obtained by coating a colored resin composition at a thickness of 1.0 to 3.0 μm.

A content of C.I.Pigment•Green 36 in the (ii) is preferably 0.90 to 1.34 g/m², more preferably 0.95 to 1.29 g/m², particularly preferably 1.01 to 1.23 g/m² in a dry film obtained by coating a colored resin composition at a thickness of 1.0 to 3.0 μm.

A content of C.I.Pigment•Blue 15:6 in the (iii) is preferably 0.59 to 0.67 g/m², more preferably 0.60 to 0.66 g/m², particularly preferably 0.61 to 0.65 g/m² in a dry film obtained by coating a colored resin composition at a thickness 1.0 to 3.0 μm.

Further, in addition to the aforementioned pigments, pigments other than the aforementioned pigments may be used by combining them. Specific examples thereof include pigments in which a color index (C.I.) number is given to the following dye or pigment, which may be used supplementarily.

—Dye or Pigment, which is Used Supplementarily—

If necessary, in addition to the aforementioned colorant (pigments), the known colorant (dye, pigment) may be added to the colored resin composition. When a pigment among the known colorant is used, it is; desirable that the pigment is uniformly dispersed in a colored resin composition and. For this reason, it is preferable that a particle diameter is 0.1 μm or smaller, particularly preferably 0.08 μm or smaller.

Examples of the known dye or pigment include Victoria•Pure Blue BO (C.I.42595), auramine (C.I.41000), Fat•Black HB (C.I.26150), C.I.Pigment•Yellow 1, C.I.Pigment•Yellow 3, C.I.Pigment•Yellow 12, C.I.Pigment•Yellow 13, C.I.Pigment•Yellow 14, C.I.Pigment•Yellow 15, C.I.Pigment•Yellow 16, C.I.Pigment•Yellow 17, C.I.Pigment•Yellow 20, C.I.Pigment•Yellow 24, C.I.Pigment•Yellow 31, C.I.Pigment•Yellow 55, C.I.Pigment•Yellow 60, C.I.Pigment•Yellow 61, C.I.Pigment•Yellow 65, C.I.Pigment•Yellow 71, C.I.Pigment•Yellow 73, C.I.Pigment•Yellow 74, C.I.Pigment•Yellow 81, C.I.Pigment•Yellow 83, C.I.Pigment•Yellow 93, C.I.Pigment•Yellow 95, C.I.Pigment•Yellow 97, C.I. Pigment•Yellow 98, C.I.Pigment•Yellow 100, C.I.Pigment•Yellow 101, C.I.Pigment•Yellow 104, C.I.Pigment•Yellow 106, C.I.Pigment•Yellow 108, C.I.Pigment•Yellow 109, C.I.Pigment•Yellow 110, C.I.Pigment•Yellow 113, C.I.Pigment•Yellow 114, C.I.Pigment •Yellow 116, C.I.Pigment•Yellow 117, C.I.Pigment•Yellow 119, C.I.Pigment•Yellow 120, C.I.Pigment•Yellow 126, C.I.Pigment•Yellow 127, C.I.Pigment•Yellow 128, C.I.Pigment •Yellow 129, C.I.Pigment•Yellow 138, C.I.Pigment•Yellow 139, C.I. Pigment•Yellow 150, C.I.Pigment•Yellow 151, C.I.Pigment•Yellow 152, C.I.Pigment•Yellow 153, C.I.Pigment •Yellow 154, C.I.Pigment•Yellow 155, (C.I.Pigment•Yellow 156, C.I.Pigment•Yellow 166, C.I.Pigment•Yellow 168, C.I.Pigment•Yellow 175, C.I.Pigment•Yellow 180, C.I.Pigment •Yellow 185; C.I.Pigment•Orange 1, C.I.Pigment•Orange 5, C.I.Pigment•Orange 13, C.I.Pigment•Orange 14, C.I.Pigment•Orange 16, C.I.Pigment•Orange 17, C.I.Pigment•Orange 24, C.I.Pigment•Orange 34, C.I.Pigment•Orange 36, C.I.Pigment•Orange 38, C.I.Pigment•Orange 40, C.I.Pigment•Orange 43, C.I.Pigment•Orange 46, C.I.Pigment•Orange 49, C.I.Pigment •Orange 51, C.I.Pigment•Orange 61, C.I.Pigment•Orange 63, C.I.Pigment•Orange 64, C.I.Pigment•Orange 71, C.I.Pigment•Orange 73; C.I.Pigment Violet 1, C.I.Pigment Violet 19, C.I.Pigment Violet 23, C.I.Pigment•Violet 29, C.I.Pigment•Violet 32, C.I.Pigment •Violet 36, C.I.Pigment Violet 38, C.I.Pigment•Red 1, C.I.Pigment•Red 2, C.I.Pigment•Red 3, C.I.Pigment•Red 4, C.I.Pigment •Red 5, C.I.Pigment•Red 6, C.I.Pigment•Red 7, C.I.Pigment•Red 8, C.I.Pigment•Red 9, C.I.Pigment•Red 10, C.I.Pigment•Red 11, C.I.Pigment•Red 12, C.I.Pigment•Red 14, C.I.Pigment•Red 15, C.I.Pigment•Red 16, C.I.Pigment•Red 17, C.I.Pigment•Red 18, C.I.Pigment•Red 19, C.I.Pigment•Red 21, C.I.Pigment•Red 22, C.I.Pigment•Red 23, C.I.Pigment•Red 30, C.I.Pigment•Red 31, C.I.Pigment•Red 32, C.I.Pigment•Red 37, C.I.Pigment•Red 38, C.I.Pigment•Red 40 C.I.Pigment•Red 41, C.I.Pigment•Red 42, C.I.Pigment•Red 48:1, C.I.Pigment•Red 48:2, C.I.Pigment•Red 48:3 C.I.Pigment•Red 48:4, C.I.Pigment•Red 49:1, C.I.Pigment•Red 49:2, C.I.Pigment•Red 50:1, C.I.Pigment•Red 52:1, C.I.Pigment•Red 53:1, C.I.Pigment•Red 57, C.I.Pigment•Red 57:1, C.I.Pigment•Red 57:2, C.I.Pigment•Red 58:2, C.I.Pigment•Red 58:4, C.I.Pigment•Red 60:1, C.I.Pigment•Red 63:1, C.I.Pigment•Red 63:2, C.I.Pigment•Red 64:1, C.I.Pigment•Red 81:1, C.I.Pigment•Red 83, C.I.Pigment•Red 88, C.I.Pigment•Red 90:1, C.I.Pigment•Red 97, C.I.Pigment•Red 101, C.I.Pigment•Red 102, C.I.Pigment•Red 104, C.I.Pigment•Red 105, C.I.Pigment•Red 106, C.I.Pigment•Red 108, C.I.Pigment•Red 112, C.I.Pigment•Red 113, C.I.Pigment•Red 114, C.I.Pigment•Red 122, C.I.Pigment•Red 123, C.I.Pigment•Red 144, C.I.Pigment•Red 146, C.I.Pigment•Red 149, C.I.Pigment•Red 150, C.I.Pigment•Red 151, C.I.Pigment•Red 166, C.I.Pigment•Red 168, C.I.Pigment Red 170, C.I.Pigment•Red 171, C.I.Pigment•Red 172, C.I.Pigment•Red 174, C.I.Pigment•Red 175, C.I.Pigment•Red 176, C.I.Pigment•Red 177, C.I.Pigment•Red 178, C.I.Pigment Red 179, C.I.Pigment•Red 180, C.I.Pigment•Red 185, C.I.Pigment•Red 187, C.I.Pigment•Red 188, C.I.Pigment•Red 190, C.I.Pigment•Red 193, C.I.Pigment•Red 194, C.I.Pigment•Red 202, C.I.Pigment•Red 206, C.I.Pigment•Red 207, C.I.Pigment Red 208, C.I.Pigment•Red 209, C.I.Pigment•Red 215, C.I.Pigment•Red 216, C.I.Pigment•Red 220, C.I.Pigment•Red 224, C.I.Pigment•Red 226, C.I.Pigment•Red 242, C.I.Pigment•Red 243, C.I.Pigment•Red 245, C.I.Pigment•Red 254, C.I.Pigment•Red 255, C.I.Pigment•Red 264, C.I.Pigment•Red 265; C.I.Pigment•Blue 15, C.I.Pigment•Blue 15:3, C.I.Pigment•Blue 15:4, C.I.Pigment•Blue 15:6, C.I.Pigment•Blue 60, C.I.Pigment•Green 7, C.I.Pigment•Green 36, C.I.Pigment•Brown 23, C.I.Pigment•Brown 25, C.I.Pigment•Black 1, C.I.Pigment•Black 7.

Specific examples of colorants preferably used in the invention include pigments and dyes described in No. JP-A No. 2005-17716, paragraphs 0038 to 0054, pigments described in JP-A No. 2004-361447, paragraphs 0068 to 0072, and colorants described in JP-A No. 2005-17521, paragraphs 0080 to 0088.

In the invention, examples of a preferable combination of the aforementioned pigments to be used jointly include: a (combination of C.I.Pigment•Red 254 and C.I.Pigment•Red 177, C.I.Pigment•Red 224, C.I.Pigment•Yellow 139 or C.I.Pigment•Violet 23; a combination of C.I.Pigment•Green 36 and C.I. Pigment•Yellow 150, C.I.Pigment•Yellow 139, C.I.Pigment•Yellow 185, C.I.Pigment•Yellow 138, or C.I.Pigment•Yellow 180; a combination of C.I.Pigment•Blue 15:6 and C.I.Pigment•Violet 23, or C.I.Pigment•Blue 60.

A content of C.I.Pigment•Reid 254 in the pigments in the case of joint use is preferably 80% by mass or more, particularly preferably 90% or more. A content of C.I.Pigment•Green 36 in the pigments in the case of joint use is preferably 50% by mass or more, particularly preferably 60% by mass or more. A content of C.I.Pigment•Blue 15:6 in the pigments in the case of joint use is preferably 80% by mass or more, particularly preferably 90% by mass or more.

It is desirable that the pigment is used as a dispersion. This dispersion can be prepared by adding a composition obtained by pre-mixing the pigment and a pigment dispersion to an organic solvent (or vehicle) described later, and dispersing this. The vehicle refers to a medium in which a pigment is dispersed when a paint is in the liquid state, and contains a part which is liquid, and binds with the pigment to solidify a coated film (binder), and a component which dissolves and dilutes this (organic solvent). A dispersing machine used when the pigment is dispersed is not particularly limited, but examples include the known dispersing machine such as a kneader, a roll mill, an atritor, a supermill, a disolver, a homomixer, and a sand mill described, Signor example, in Section 438 of “Dictionary of Pigment” authored by Kunizo Asakura, first edition, Asakurashoten, 2000. Further, a pigment may be finely-divided utilizing a friction force by mechanical grinding described in the reference, Section 310.

A number average particular diameter of a colorant (pigment particle) used in the invention is preferably 0.001 to 0.1 μm, further preferably 0.01 to 0.08 μm. When a number average particle diameter of the pigment is 0.001 to 0.1 μm, the dispersion state can be stably retained and, at the same time, reduction in a contrast due to depolarization by the pigment is not caused, and this is preferable. The “particle diameter” used herein refers to a diameter when an electron microgram image of a particle is assumed to be a circle having the same area, and the “number average particle diameter” refers to an average of 100 particles when the aforementioned particle diameter is obtained regarding many particles.

The contrast of a colored pixel defined in the invention can be attained by reducing a particle diameter of a dispersed pigment. Reduction in a particle diameter can be attained by regulating a dispersing time of a pigment dispersion. For dispersing a pigment, the aforementioned known dispersing machine can be used. A dispersing time is preferably 10 to 35 hours, more preferably 10 to 30 hours, further preferably 18 to 30 hours, most preferably 24 to 30 hours. When a dispersing time is less than 10 hours, a pigment particle diameter is large, depolarization due to a pigment may be generated, a contrast may be reduced in some cases. On the other hand, when a dispersing time exceeds 35 hours, a viscosity of a dispersion may be increased, and coating may become difficult in some cases.

In order to make the difference between the contrast of the colored pixel having the lowest contrast, and the contrast of the colored pixel having the highest contrast not more than 600, a pigment particle diameter may be regulated to obtain a desired contrast.

The colored resin composition forming the color filter in the invention is preferably a colored resin composition containing at least (1) an alkali-soluble resin, (2) a monomer or an oligomer, and (3) a photopolymerization initiator or a photopolymerization initiator system, in addition to the colorant.

These components (1) to (3) will be explained below.

### (1) Alkali-Soluble Resin

As an alkali-soluble resin in the invention (hereinafter, simply referred to as “binder” in some cases), a polymer having a polar group such as a carboxylic acid group or a carboxylic acid group on a side chain is preferable. Examples include a methacrylic acid copolymer, an acrylic acid copolymer, an itaconic acid copolymer, a crotonic acid copolymer, a maleic acid copolymer, and a partially esterified maleic acid copolymer described in JP-A No. 59-44615, Japanese Patent Application Publication (JP-B) No. 54-34327, JP-B No. 58-12577, JP-B No. 54-25957, JP-A No. 59-53836 and JP-A No. 59-71048. A cellulose derivative having a carboxylic acid group on a side chain is also an example. A polymer having a hydroxy group to which a cyclic acid anhydride is added can be also preferably used. Particularly preferable examples include a copolymer of benzyl (meth)acrylate and (meth)acrylic acid, and a multiple copolymer of benzyl (meth)acrylate, (meth)acrylic acid and another monomer described in U.S. Pat. No. 4,139,391. These binder polymers having a polar group may be used alone, or may be used in the state of a composition in which a normal film-forming polymer is used jointly. A content of the binder polymer having a polar group relative to a total solid content of the colored resin composition is generally 20 to 50% by mass, preferably 25 to 45% by mass.

### (2) Monomer or Oligomer

It is preferable that a monomer or an oligomer in the invention is a monomer or an oligomer, which has two or more ethylenic unsaturated double bonds, and is addition-polymerized by light irradiation. Examples of thereof include compounds which have at least one addition-polymerizable ethylenic unsaturated group in a molecule, and has a boiling point of 100° C. or higher at a normal pressure. Examples include monofunctional acrylates and monofunctional methacrylates such as polyethylene glycol mono(meth)acrylate, polypropylene glycol mono(meth)acrylate and phenoxyethyl (meth)acrylate; polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, di-pentaerythritol penta(meth)acrylate, hexanediol di(meth)acrylate, trimethylolpropane tri(acryloyloxypropyl)ether, tri(acryloyloxyethyl) isocyanurate, tri(acryloyloxyethyl) cyanurate, glycerin tri(meth)acrylate; polyfunctional acrylates and polyfunctional methacrylates obtained by adding ethylene oxide or propylene oxide to a polyfunctional alcohol such as trimethylol propane and glycerin, and (meth)acrylating this.

Further examples include urethane acrylates described in JP-B No. 48-41708, JP-B No. 50-6034 and JP-A No. 51-37193; polyester acrylates described in JP-B No. 49-43191 and JP-B No. 52-30490; polyfunctional acrylates and methacrylates such as epoxy acrylate which is a reaction product of an epoxy resin and (meth)acrylic acid. Among them, trimethylolpropane tri(meth)acrylate, pentaerythritol tetra(meth)acrylate, dipentaerythritol hexa(meth)acrylate, and dipentaerythritol penta(meth)acrylate are preferable.

Additionally, preferable examples include a “polymerizable compound B” described in JP-A No. 11-133600.

These monomers and oligomers may be used alone, or by mixing two or more kinds. A content the monomor or oligomer relative to a total solid content of the colored resin composition is generally 5 to 50% by mass, preferably 10 to 40% by mass.

### (3) Photopolymerization Initiator or Photopolymerization Initiator System

Examples of photopolymerization initiator or a photopolymerization initiator system in the invention include a vicinal polyketaldonyl compound disclosed in U.S. Pat. No. 2,367,660, an acyloin ether compound described in U.S. Pat. No. 2,448,828, an aromatic acyloin compound substituted with a-hydrocarbon described in U.S. Pat. No. 2,722,512, a polynuclear quinone compound described in U.S. Pat. No. 3,046,127 and U.S. Pat. No. 2,951,758, a combination of a triarylimidazole dimer and p-aminoketcne described in U.S. Pat. No. 3,549,367, a benzothiazole compound and a trihalomethyl-s-triazine compound described in JP-B No. 51-48516, a trihalomethyl-triazine compound described in U.S. Pat. No. 4,239,850, and a trihalomethyloxadiazole compound described in U.S. Pat. No. 4,212,976. Particularly, trihalomethyl-s-triazine, trihalomethyloxadiazole and triarylimidazole dimer are preferable.

In addition, a photopolymerization initiator or a photopolymerization initiator system, which can be applied to the invention, is described in JP-A No. 2004-317898 (Paragraph 0026), and JP-A No. 2003-111378 (paragraphs 0064 to 0087).

Additionally, preferable examples include a “polymerization initiator C” described in JP-A No. 11-133600.

These photopolymerization initiators or photopolymerization initiator systems may be used alone, or by mixing two or more kinds. It is particularly preferable to use two or more kinds. When at least two kinds of photopolymerization initiators are used, display property can be improved and, particularly, a scalier of display can be reduced.

A content of the photopolymerization initiator or photopolymerization initiator system relative to a total solid content of the colored resin composition is generally 0.5 to 20% by mass, preferably 1 to 15% by mass.

### (Other Additives)

—Solvent—

In the invention, in addition to the aforementioned components, an organic solvent may be further used in the colored resin composition. Examples of the organic solvent include methyl ethyl ketone, propylene glycol monomethyl ether, propylene glycol monomethyl ether acetate, cyclohexanone, cyclohexanol, methyl isobutyl ketone, ethyl lactate, methyl lactate, and caprolactam.

### —Surfactant—

In the color filter, which has conventionally been used, there was a problem that a color of each pixel is concentrated for realizing high color purity, and an uneven film thickness of a pixel is, as it is, recognized as an uneven color. For this reason, improvement in a film thickness variation at formation (coating) of a resin layer, which directly influences on a film thickness of a pixel, has been sought.

In the color filter of the invention, from a viewpoint of control of a uniform film thickness, and effective prevention of an uneven coating (uneven color due to film thickness variation), it is preferable that the colored resin composition contains a suitable surfactant.

Preferable examples of the surfactant include surfactants disclosed in JP-A No. 2003-337424, and JP-A No. 11-133600.

### —Thermal Polymerization Inhibitor—

In the invention, it is preferable that a colored resin composition contains a thermal polymerization initiator. Examples of the thermal polymerization inhibitor include hydroquinone, hydroquinone monomethyl ether, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), 2-mercaptobenzimidazole, and phenothiazine. Examples of the thermal polymerization inhibitor further include those described in JP-A No. 2004-317898 (paragraph 0029).

### —Ultraviolet-Ray Absorbing Agent—

In the invention, if necessary, the colored resin composition can contain a ultraviolet-ray absorbing agent. Examples of the ultraviolet-ray absorbing agent include compounds described in JP-A No. 5-72724, salicylate series, benzophenone series, benzotriazole series, cyanoacrylate series, nickel chelate series, and hindered amine series.

Specifically, examples include phenyl salicylate, 4-t-butylphenyl salicylate, 2,4-di-t-butylphenyl-3′,5′-di-t-4′-hydroxybenzoate, 4-t-butylphenyl salicylate, 2,4-dihydroxybenzophenone, 2-hydroxy-4-methoxybenzophenone, 2-hydroxy-4-n-octoxybenzophenone, 2-(2′-hydroxy-5′-methylphenyl)benzotriazole, 2-(2′-hydroxy-3′-t-butyl-5′-methylphenyl)-5-chlorobenzotriazole, ethyl-2-cyano-3,3-diphenyl acrylate, 2,2′-hydroxy-4-methoxybenzophenone, nickel dibutyl dithiocarbamate, bis(2,2,6,6-tetramethyl-4-pyridine-sebacate, 4-t-butylphenyl salicylate, phenyl salicylate, 4-hydroxy-2,2,6,6-tetramethylpiperidine condensate, succinic acid-bis(2,2,6,6-tetramethyl-4-piperidinyl)-ester, 2-[2-hydroxy-3,5-bis(α,α-dimethylbenzyl)phenyl]-2H-benzotriazole, and 7-{[4-chloro-6-(diethylamino)-5-triazin-2-yl]amino}-3-phenylcoumarin.

Details are also described in JP-A No. 2003-5382 (paragraphs 0080 to 0081).

In the invention, the colored resin composition may contain an “adhesion assistant” described in JP-A No. 11-133600, and other additives in addition to the aforementioned additives.

### <Resin Transferring Material>

The color filter of the invention can be manufacture by transferring a resin transferring material (photosensitive resin transferring material). It is preferable to form the filter using a resin transferring material described in JP-A No. 5-72724, that is, an integrated-type film. Examples of construction of the integrated-type film include construction in which provisional support/thermoplastic resin layer/intermediate layer/resin layer/protecting film are laminated in this order.

In the invention, the resin layer of the resin transferring material can be formed by using the aforementioned colored resin (composition.

### (Provisional Support)

It is preferable that a provisional support of the resin transferring material has flexibility, and does not generate remarkable deformation, shrinkage or elongation under pressure, or under pressure and heating. Examples of such the support include a polyethylene terephthalate film, a cellulose triacetate film, a polystyrene film, and a polycarbonate film and, inter alia, a biaxially stretched polyethylene terephthalate film is particularly preferable.

A thickness of a provisional support is not particularly limited, but a range of 5 to 200 μm is general, particularly, a range of 10 to 150 μm is advantageous and preferable from a viewpoint of easy handling, and multiple usage. In addition, the provisional support may be transparent, or may contain silicon converted into a dye, alumina sol, chromium salt, or a zirconium salt.

### (Thermoplastic Resin Layer)

As a component used in a thermoplastic resin layer, an organic polymer substance disclosed in JP-A No. 5-72724 is preferable, and it is particularly preferable that a component is selected from organic polymer substances having a softening point of about 80° C. or lower as measured by a Vicat method (specifically, a polymer softening point measuring method according to American Material Testingg Method, ASTMD1235). Specifically, examples include organic polymers such as polyolefin such as polyethylene and polypropylene, an ethylene copolymer such as a copolymer of ethylene and vinyl acetate, and a saponified entity thereof, ethylene and acrylic acid ester, or a saponified entity thereof, polyvinyl chloride, a vinyl chloride copolymer such as a copolymer of vinyl chloride and vinyl acetate, and a saponified entity thereof, polyvinylidene chloride, a polyvinylidene chloride copolymer, polystyrene, a styrene copolymer such as a copolymer of styrene and (meth)acrylic acid ester, or a saponified entity thereof, polyvinyltoluene, a polyvinyltoluene copolymer such as a copolymer of vinyltoluene and (meth)acrylic acid ester, or a saponified entity thereof, poly(meth)acrylic acid ester, a (meth)acrylic acid ester copolymer such as a copolymer of butyl (meth)acrylate and vinyl acetate, and a polyamide resin such as a vinyl acetate copolymer nylon, copolymerized nylon, N-alkoxymethylated nylon, and N-dimethylaminated nylon. Additionally, the description of JP-A No. 2004-205732 (paragraphs 0038 to 0044) can be referred.

### (Intermediate Layer)

In the resin transferring material, it is preferable to provide an intermediate layer in order to prevent mixing of components at coating of a plurality of coated layers and at storage after coating. It is preferable to use an oxygen shielding film having oxygen shielding function described as a “separating layer” in JP-A No. 5-72724 as the intermediate layer and, in this case, sensitivity at exposure is increased, time load of an exposing machine is decreased, and productivity is improved.

As the oxygen shielding film, a film, which exhibits low oxygen permeability, and is dispersed or dissolved in water or an aqueous alkali solution is preferable, and the film can be appropriately selected among the known films. As a resin, which can be used in an intermediate layer, the description of JP-A No. 2005-17521 (paragraphs 0095 to 0101) can be referred and, among them, particularly preferable is a combination of polyvinyl alcohol and polyvinylpyrolidone.

### (Protecting Film)

It is preferable to provide a thin protecting film on a thermoplastic resin layer in order to protect from contamination and damage upon storage. The protecting film may consist of a material identical or similar to that of the provisional support, and must be easily peeled from a thermoplastic resin layer. Its a material for the protecting film, for example, a silicone paper, and a polyolefin or polytetrafluoroethylene sheet are suitable.

### (Process for Manufacturing Resin Transferring Material)

The resin transferring material can be manufactured by coating with a coating solution in which components of a thermoplastic resin layer is dissolved (coating solution for thermoplastic resin layer) on a provisional support, and drying this to provide a thermoplastic resin layer, thereafter, coating a solution for an intermediate layer material containing a solvent which does not dissolve a thermoplastic resin layer on a thermoplastic resin layer, and drying this and, thereafter, providing a resin layer of a colored resin composition by coating and drying using a solvent which does not dissolve an intermediate layer.

Alternatively, the resin transferring material can be also manufactured by preparing a sheet in which a thermoplastic resin layer and an intermediate layer are provided on the aforementioned provisional support, and a sheet in which a resin layer is provided oil a protecting film, and laminating them so that the intermediate layer and the resin layer are contacted, or by preparing a sheet in which a thermoplastic resin layer is provided on the provisional support, and a sheet in which a resin layer and an intermediate layer are provided on a protecting film, and laminating them so that the thermoplastic resin layer and the intermediate layer are contacted.

In the resin transferring material, a thickness of a resin layer of a colored resin composition is preferably 1.0 to 5.0 μm, more preferably, 1.0 to 4.0 μm, particularly preferably 1.0 to 3.0 μm.

A preferable thickness of other each layer is not particularly limited, but generally preferably, a thickness of a thermoplastic resin layer is 2 to 30 μm, a thickness of an intermediate layer is 0.5 to 3.0 μm, and thickness of a protecting film is 4 to 40 μm.

Coating in the aforementioned manufacturing method can be performed by the known coating apparatus and, in the invention, it is preferable to perform coating by using a coating apparatus (slit coater) using a slit-like nozzle.

### (Slit-Like Nozzle)

The resin transferring material can be formed by coating a colored resin composition by the known coating method, and drying this and, in the invention, it is preferable to perform coating with a slit-like nozzle having a slit-like hole at a part through which a solution is discharged. Specifically, a slit-like nozzle, and a slit coater described in JP-A No. 2004-89851, JP-A No. 2004-17043, JP-A No. 2003-170098, JP-A No. 2003-164787, JP-A No. 2003-10767, JP-A No. 2002-79163, and JP-A No. 2001-310147 are suitably used.

### <Process for Manufacturing Color Filter>

### (Resin Layer)

The color filter of the invention is preferably such that respective resin layers of red (R), green (G) and blue (B) are formed from the colored resin composition using at least C.I.Pigment•Red 254 as a colorant, the colored resin composition using at least C.I.Pigment•Green 36, and the colored resin composition using at least C.I.Pigment•Blue 15:6, respectively.

Use of the colorants as described above is effective to have a high contrast and, particularly, even when the color filter is used in a large screen liquid display device, realize a high color purity and wide color reproductivity.

The color filter of the invention can be manufactured by the known method such as a method of repeating formation of a resin layer on a substrate, and development by exposure, times by the number of colors. If necessary, a structure in which a boundary is compartmented with a black matrix may be adopted.

In the above process, examples of the method of forming the resin layer on a substrate include (a) a method of coating the respective colored resin compositions by using the known coating apparatus, and (b) a method of laminating the resin transferring material by using a laminator.

### (a) Coating by Using Coating Apparatus

In the process for manufacturing the color filter of the invention, a colored resin composition can be coated by the known coating method such as a spin coating method, a curtain coating method, a slit coating method, a dip coating method, an air-knife coating method, a roller coating method, a wire bar coating method, a gravure coating method, and an extrusion coating method using a hopper described in U.S. Pat. No. 2,681,294. Inter alia, particularly, a slit coater which was already explained in <Resin transferring material> can be suitably used. Preferable examples of the slit coater include those described above. When a resin layer is formed by coating, a film thickness thereof is preferably 1.0 to 3.0 μm, more preferably 1.0 to 2.5 μm, particularly preferably 1.0 to 2.0 μm.

(b) Lamination with Laminator

A resin layer formed into a film can be laminated on a substrate described later by using the resin transferring material and by pressing or heat-pressing with a heated and/or pressed roller or plate. Examples include a laminator and a laminating method described in JP-A No. 7-110575, JP-A No. 11-77942, JP-A No. 2000-334836, and JP-A No. 2002-148794. From a viewpoint of a small amount of a foreign matter, it is preferable to use the method described in JP-A No. 7-110575. A preferable film thickness when a resin layer is formed by using the resin transferring material is the same as a preferable film thickness described in

### <Transferring Material>

### (Substrate)

In the invention, as a substrate on which a color filter is formed, for example, a transparent substrate is used, and examples include the known glass plate such as a soda glass plate having a silicon oxide film on a surface, a low thermal expansion glass, an alkali-free glass, and a quartz glass plate, as well as a plastic film.

In the substrate, adherability with a colored resin composition or a resin transferring material can be made to be better by performing coupling treatment in advance. As the coupling treatment, the method described in JP-A No. 2000-39033 is suitably used. A film thickness of the substrate is not particularly limited, but is generally preferably 700 to 1200 μm.

### (Oxygen Shielding Film)

Upon manufacturing of the color filter of the invention, when a resin layer is formed by coating a colored resin composition, an oxygen shielding film can be further provided on the resin layer, thereby, an exposure sensitivity can be increased. Examples of the oxygen shielding film include the same films as those already explained in (Intermediate layer) of <Resin transferring material>. A film thickness of an oxygen shielding film is not particularly limited, but is preferably 0.5 to 3.0 μm.

### (Exposure and Development)

The color filter can be obtained by repeating a step of placing a prescribed mask above a resin layer formed on a substrate, thereafter, irradiating light from above the mask via the mask, a thermoplastic resin layer and an intermediate layer and, then, performing development with a developer, times by the number of colors.

Herein, as a light source for the exposure, a light source can be appropriately selected and used as far as it can irradiate light of a wavelength region at which a resin layer can be cured (e.g. 365 nm, 405 nm etc.). Specifically, examples include a ultrahigh pressure mercury lamp, a high pressure mercury lamp, and a metal halide lamp. An exposure light amount is usually around 5 to 200 mJ/cm², preferably around 10 to 100 mJ/cm².

The developer is not particularly limited, but the known developer such as the developer described in JP-A No. 5-72724 can be used. A developer in which a resin layer behaves dissolution-type development is, preferable. For example, a developer containing a compound of pKa=7 to 13 at a concentration of 0.05 to 5 mol/L is preferable. Further, a small amount of an organic solvent having miscibility with water may be added.

Examples of the organic solvent having miscibility with water include methanol, ethanol, 2-propanol, 1-propanol, butanol, diacetone alcohol, ethylene glycol monomethyl ether, ethylene glycol monoethyl ether, ethylene glycol, mono-n-butyl ether, benzyl alcohol, acetone, methyl ethyl ketone, cyclohexanone, ε-caprolactone, γ-butyrolactone, dimethylformamide, dimethylacetamide, hexamethylphosphoramide, ethyl lactate, methyl lactate, c-caprolactam, and N-methylpyrrolidone. A concentration of the organic solvent is preferably 0.1% by mass to 30% by mass.

Further, the known surfactant may be added to the developer. A concentration of the surfactant is preferably 0.01% by mass to 10% by mass.

As a method of development, the known method such as paddle development, shower development, shower & spin development, and dipping development can be used.

Herein, to explain the shower development, an uncured part can be removed by blowing a developer to a resin layer after exposure with a shower. It is preferable to blow an alkaline solution in which a resin layer is less soluble with a shower before development, to remove a thermoplastic resin layer and an intermediate layer. It is preferable to blow a detergent with a shower after development, and remove the development residue while it is rubbed with a brush.

As the detergent, the known one can be used, and (trade name: T-SD1, manufactured by Fuji Photo Film Co., Ltd., containing phosphate, silicate, nonionic surfactant, anti-foaming agent and stabilizer, or trade name: T-SD2, manufactured by Fuji Photo Film Co., Ltd., containing sodium carbonate, and phenoxyoxyethylene-based surfactant) are preferable.

A liquid temperature of a developer is preferably 20° C. to 40° C., and a pH of a developer is preferably 8 to 13.

In manufacturing of the color filter, it is preferable from a viewpoint of lowering in cost to form a base by overlaying a colored resin composition forming a color filter, form a transparent electrode thereon, and form a spacer by overlaying a projection for partition orientation, as described in JP-A No. 11-248921, and Japanese Patent No. 3255107.

When colored resin compositions are overlaid by successive coating, a film thickness is reduced every overlaying due to leveling of a coating solution. For this reason, it is preferable to overlay four colors of K (black)•R•G•B, and further overlay a projection for partition orientation. On the other hand, when a transferring material having a thermoplastic resin layer is used, since a thickness is retained constant, overlaying colors are preferably 3 or 2 colors.

From a viewpoint of prevention of deformation of a resin layer upon overlaying and lamination of a transferring material, and maintenance of a constant thickness, a size of the base is preferably 25 μm×25 μm or greater, particularly preferably 30 μm×30 μm or greater.

### <Liquid Crystal Display Device>

The liquid crystal display device of the present invention is not particularly limited as far as it is provided with the color filter of the invention in which the contrast of each colored pixel is not lower than 2000 and, among the aforementioned colored pixels of two or more colors, the difference between the contrast of a colored pixel having the lowest contrast and the contrast of a colored pixel having the highest constant is not more than 600. Various display modes such as ECB (Electrically Controlled Birefringence), TN (Twisted Nematic), IPS (In-Plane Switching), FLC (Ferroelectric Liquid Crystal), OCB (Optically Compensatory Bend), STN (Super Twisted Nematic), VA (Vertically Aligned), HAN (Hybrid Aligned Nematic), and GH (Guest Host) can be adopted. The device is characterized in that the aforementioned color filter is used, thereby, high color purity can be realized and, at the same time, high display quality can be realized, and the apparatus can be suitably used also in a large screen liquid crystal display device such as a display for a notebook computer and a television monitor.

In an embodiment, the liquid crystal display device of the invention is a liquid crystal display device including a backlight, a polarizing plate, at least two substrates, a liquid crystal layer held by the substrates, an electrode provided on at least one part of the substrates, and the color filter provided on at least one part of the substrates, in which the cooler filter layer is the color filter of the invention, the polarizing plate has a polarization degree of 99.95 or higher, and an crossed transmittance at 400 nm of 0.05% or smaller. By using a combination of a pixel having a high contrast and a polarizing plate having a high contrast, a liquid crystal display device which displays a vivid image having a high contrast, is balanced in contrasts of respective pixels of RGB, and is excellent in black display property can be provided.

### <Polarizing Plate>

In an embodiment of the invention, a polarization degree of the polarizing plate is 99.95 or higher, more preferably 99.97 or higher, most preferably 99.99 or higher. When a polarization degree is less than 99.95, even if a contrast of a color filter layer is enhanced to 2000 or higher, light leakage due to a polarizing plate may be occurred, a display concentration of black may be decreased, and this is not preferable.

Polarization degree is defined as follows:

Polarization degree=((Tp−Tc)/(Tp+Tc))^{0.5}×100

Tp: transmittance when polarizing plates are combined parallel
Tc: transmittance when polarizing plates are combined orthogonal

From a viewpoint of suppression of black balance shift generated at a high contrast, in an embodiment of the invention, the polarizing plate is such that the polarization degree is 99.95 or higher and, additionally, a crossed transmittance at 400 nm is 0.05% or lower. The crossed transmittance is more preferably 0.03% or lower, further preferably 0.01% or lower. When the crossed transmittance exceeds 0.05%, black balance shift generated at a high contrast may easily occur.

The polarizing plate in the invention is manufactured, for example, by stain-adsorbing iodine or a dye onto polyvinyl alcohol, followed by stretching and orientation. Thereby, function as a polarizing plate through which only polarized light in a certain vibration direction is passed, is manifested. Preferable examples of the polarizing plate of iodine type include HCL2-5618 (polarization degree 99.979, crossed transmittance at 400 nm: 0.01%), HLC2-2518 (polarization degree 99.991, crossed transmittance at 400 nm: 0.01%), UHLC2-5618 (polarization degree 99.975, crossed transmittance at 400 nm: 0.01%), LLC2-9118 (polarization degree 99.982, crossed transmittance at 400 nm: 0.01%), LLC2-9218 (polarization degree 99.974, crossed transmittance at 400 nm: 0.02%), and LLC2-81-18 (polarization degree 99.985, crossed transmittance at 400 nm: 0.01%) manufactured by Sanritz Corporation. Preferable examples of the polarizing plate of a dye type include HC2-6018 (polarization degree 99.952, crossed transmittance at 400 nm: 0.02%) manufactured by Sanritz Corporation. Among them, from a viewpoint of maintenance of a contrast over a long period of time, a polarizing plate of an iodine type is preferable. From a viewpoint of color balance, a polarizing plate having a color of gray type is more preferable (e.g. HLC2-5618 (gray), HLC2-2518 (gray), UHLC2-5618 (gray), LLC2-9118 (gray), LLC2-9218 (gray), LLC2-81-18 (gray) manufactured by Sanritz Corporation). Further, from a viewpoint of suppression of black balance shift generated at a high contrast, for example, HLC2-2518 (0.01%) manufactured by Sanritz Corporation, which has a crossed transmittance at 400 nm of 0.05% or lower is most preferable.

### (Liquid Crystal Layer)

As the liquid crystal layer used in the invention, various liquid crystal modes such as ECB (Electrically Controlled Birefringence), TN (Twisted Nemetic), IPS (In-Plane Switching), FLC (Ferroelectric Liquid Crystal), OCB (Optically Compensatory Bend), STN (Super Twisted Nematic), VA (Vertically Aligned), HAN (Hybrid Aligned Nematic), and GH (Guest Host) can be used. Among them, preferable is a layer of a liquid crystal used in a liquid crystal mode such as TN, MVA, IPS, PVA and OCB. MVA, IPS (super IPS), PVA and OCB modes having high animation displaying property and little viewing angle independency are more preferable, and PVA mode having a high black contrast, MVA mode in which a measure for light leakage around an orientation control projection is taken, and IPS (super IPS) mode having an enhanced contrast are most preferable.

### (Electrode)

An electrode used in the invention refers to an electrode for applying the electric field to a liquid crystal molecule of a liquid crystal layer. In the case of a liquid crystal mode such as TN, MVA, PVA and OCB, an electrode is formed on a liquid crystal side of two substrates holding a liquid crystal layer; In the case of an IPS mode, an electrode is provided on at least one side of two substrates holding a liquid crystal. As a material, for example, indium tin oxide (ITO) may be used.

### (Screen Size)

In the invention, as a screen size grows greater, the effect is manifested more remarkably. Therefore, a screen size of the liquid crystal display device of the invention is preferably 10 inch or more, more preferably 15 inch or more, most preferably 20 inch or more.

### (Backlight)

In the invention, as the backlight, a cold cathode tube (CCFL), an external electrode cold cathode tube (EEFL), FFL, and LED can be utilized.

As the cold cathode tube (CCFL), generally, a cold cathode tube, which uses a light source having an emission wavelength in wavelength regions of red, green and blue, in which light emission from this cold cathode tube is converted into a white planar light source with a light guiding plate, is used. Among a luminous body of the cold cathode tube, as a red luminous body, a Y₂O₃:Eu fluorescent body is generally used. As a green luminous body, a LaPO₄:Ce,Tb fluorescent body is generally used. As a blue luminous body, a BaMgAl₁₀O₁₇:Eu fluorescent body and a Sr₁₀(PO₄)₆Cl₂:Eu fluorescent body are generally used. A fluorescent lamp in which an electrode is mounted in a sealing body in which a fluorescent body film obtained by mixing these fluorescent bodies at an appropriately blending ratio in view of white balance is provided, and a rare gas is encapsulated therein, is used as a light source for a backlight.

It is preferable to use a light emitting device having a peak wavelength between 520 to 540 nm as LED. More specifically, a light emitting diode is used. A backlight using this light emitting diode is described in detail in JP-A No. 2004-78102.

That is, a LED backlight which contains red (R) LED, green (G) LED, and blue (B) LED, and in which a peak wavelength of the red (R) LED is 610 nm or more, a peak wavelength of the green (G) LED is in a range of 530±10 nm, and a peak wavelength of the blue (B) LED is 480 nm or less, is preferably used. Particularly, by a peak wavelength of the green (G) LED in a range of 520 to 540, it becomes possible to widen a reproduction region of green of the liquid crystal display device of the invention. In the invention, a peak wavelength of the green (G) LED is preferably in a range of 520 to 540 nm, more preferably in a range of 525 to 535 nm. Examples of a kind of green (G) LED having a peak wavelength in the aforementioned range include DG1112H (manufactured by Stanley Electric Co., Ltd.), UG1112H (manufactured by Stanley Electric Co., Ltd.), E1L51-3G (manufactured by Toyoda Gosei Co., Ltd.), E1L49-3G (manufactured by Toyoda Gosei Co., ltd.), and NSPG500S (manufactured by Nichia Corporation).

In the invention, as a light source for a LED backlight, red (R) LED is also preferably used. In this case, the LED is not particularly limited as far as it is LED having a peak wavelength of 610 nm or more. A peak wavelength of the red (R) LED is preferably 610 nm or more, more preferably in a range of 615 nm to 640 nm. Thereby, a chromaticity point of red NTSC specification can be reproduced by the liquid crystal display device.

Examples of the red (R) LED include FR1112H (manufactured by Stanley Electric Co., Ltd.), FR5366X (manufactured by Stanley Electric Co., Ltd.), NSTM515AS (R) (manufactured by Nichia Corporation), GL3ZR2D1COS (manufactured by Sharp Corporation), and GM1JJ35200AE (manufactured by Sharp Corporation).

In the invention, as a light source for a LED backlight, blue (B) LED is also preferably used. In this case, the LED i<; not particularly limited as far as it is LED having a peak wavelength of 480 nm or less. A peak wavelength of the blue (R) LED is preferably 480 nm or less, more preferably in a range of 465 nm to 475 nm. Thereby, a chromaticity point of blue NTSC specification can be reproduced by the liquid crystal display device of the invention.

Examples of the blue (B) LEI) include DB1112H (manufactured by Stanley Electric Co., Ltd.), DB5306X (manufactured by Stanley Electric Co., Ltd.), E1L51-3B (manufactured by Toyoda Gosei Co., Ltd.), E1L4E-SB1A (manufactured by Toyoda Gosei Co., Ltd.), NSPB630S (manufactured by Nichia Corporation), and NSPB310A (manufactured by Nichia Corporation).

Peak wavelengths described herein were obtained from spectral measurement values using a photospectrometer apparatus MCPD-2000 manufactured by Otsuka Electronics Co., Ltd.

The disclosures of Japanese Patent Application Nos. 2004-296385 and 2005-58015 are incorporated by reference herein.

### EXAMPLES

The present invention will be explained in more detail using Examples, but the invention is not limited to these Examples. Hereinafter, unless otherwise indicated, “part” and “%” indicate “part by mass” and “% by mass” respectively.

### Examples 1 to 8 and 9a to 16a and Comparative Examples 1 and 2

### Example 1

### Manufacturing of Color Filter

—Manufacturing of Photosensitive Resin Transferring Material—

A coating solution for a thermoplastic resin layer consisting of the following formulation H1 was coated on a polyethylene terephthalate film provisional support having a thickness of 75 μm using a slit-like nozzle, and this was dried. Then, a coating solution for an intermediate layer consisting of the following formulation P1 was coated, and dried. Further, a colored photosensitive resin composition K1 consisting of a composition of a formulation K1 described in the following Table 1 was coated, and dried, to provide a thermoplastic resin layer having a dry film thickness of 14.6 μm, an intermediate layer having a dry film thickness of 1.6 μm, and a photosensitive resin layer having a dry film thickness of 2.4 μm on the provisional support, and a protecting film (polypropylene film having thickness of 12 μm) was adhered by pressure.

Thus, a photosensitive resin transferring material in which the provisional support, the thermoplastic resin layer, the intermediate layer (oxygen shielding film) and the black (K) photosensitive resin layer were integrated was manufactured, and the photosensitive resin transferring material was designated as K1.

Coating solution for thermoplastic resin layer: formulation H1

| | |
|---|---|
| Methanol | 11.1 parts |
| Propylene glycol monomethyl ether acetate | 6.36 parts |
| Methyl ethyl ketone | 52.4 parts |
| Methyl methacrylate/2-ethylhexyl acrylate/benzyl methacrylate/methacrylic acid copolymer | 5.83 parts |
| (copolymerization compositional ratio (mole ratio) = 55/11.7/4.5/28.8, weight average | |
| molecular weight = 100,000, Tg = 70° C. | |
| Styrene/acrylic acid copolymer (copolymerization compositional ratio (mole ratio) = 63/37, | 13.6 parts |
| weight average molecular weight = 10,000, Tg = 100° C.) | |
| Compound in which 2 equivalent of pentaethylene glycol monomethacrylate is | 9.1 parts |
| dehydration-condensed with bisphenol A (trade name: 2,2-bis[4-(methacryloxy | |
| polyethoxy)phenyl]propane, manufactured by Shin-Nakamura Chemical Co., Ltd.) | |
| Surfactant 1 (trade name: MEGAFACE F780F, manufactured by Dainippon Ink and | 0.54 part |
| Chemicals, Incorporated) | |

Coating solution for intermediate layer: formulation P1

| | |
|---|---|
| PVA205 (polyvinyl alcohol, manufactured by Kurary Co., | 32.2 parts |
| Ltd., saponification degree = 88%, polymerization | |
| degree 550) | |
| Polyvinylpyrrolidone (trade name: K-30, manufactured by | 14.9 parts |
| ISP Japan, Ltd.) | |
| Distilled water | 524 parts |
| Methanol | 429 parts |

Then, according to the same manner as that described above except that the colored photosensitive resin composition K1 used in manufacturing of the photosensitive resin transferring material K1 was changed to the following colored photosensitive resin composition R1, G1 or B1 consisting of a composition described in the following in Table 1, photosensitive resin transferring materials R1, G1 and B1 were manufactured.

TABLE 1
Unit: part by mass

| Colored photosensitive | Examples 1 to 7, Comparative Examples 1, 2 | | | | Example 8 | | |
|---|---|---|---|---|---|---|---|
| resin composition | K1 | R1 | G1 | B1 | R2 | G2 | B2 |
| K pigment dispersion 1 | 25 | — | — | — | — | — | — |
| R pigment dispersion 1 | — | 44 | — | — | 44 | — | — |
| (C.I.P.R.254) | | | | | | | |
| R pigment dispersion 2 | — | 5.0 | — | — | 5.0 | — | — |
| (C.I.P.R.177) | | | | | | | |
| G pigment dispersion 1 | — | — | 24 | — | — | — | — |
| (C.I.P.G.36) | | | | | | | |
| G pigment dispersion 2 | — | — | — | — | — | 24 | — |
| (C.I.P.G.36) | | | | | | | |
| Y pigment dispersion 1 | — | — | 13 | — | — | — | — |
| (C.I.P.Y.150) | | | | | | | |
| Y pigment dispersion 2 | — | — | — | — | — | 13 | — |
| (C.I.P.Y.150) | | | | | | | |
| B pigment dispersion 1 | — | — | — | 26 | — | — | — |
| (C.I.P.B. 15:6 + | | | | | | | |
| C.I.P.V.23) | | | | | | | |
| B pigment dispersion 2 | — | — | — | — | — | — | 7.2 |
| (C.I.P.B. 15:6) | | | | | | | |
| B pigment dispersion 3 | — | — | — | — | — | — | 13 |
| (C.I.P.B. 15:6 + | | | | | | | |
| C.I.P.V.23) | | | | | | | |
| Propylene glycol | 8.0 | 7.6 | 32 | 27 | 7.6 | 29 | 23 |
| monomethyl ether | | | | | | | |
| acetate | | | | | | | |
| Methyl ethyl ketone | 53 | 37 | 26 | 35 | 37 | 26 | 35 |
| Cyclohexanone | — | — | 1.3 | — | — | 1.3 | — |
| Binder 1 | 9.1 | — | — | — | — | 3.0 | — |
| Binder 2 | — | 0.8 | — | — | 0.8 | — | — |
| Binder 3 | — | — | — | 6.7 | — | — | 17 |
| DPHA solution | 4.2 | 4.4 | 4.6 | 4.4 | 4.4 | 4.3 | 3.8 |
| 2-Trichloromethyl-5-(p- | — | 0.14 | 0.16 | 0.17 | 0.14 | 0.15 | 0.15 |
| styrylmethyl)1,3,4- | | | | | | | |
| oxadiazole | | | | | | | |
| 2,4-Bis(trichloromethyl)- | 0.16 | 0.06 | 0.06 | — | 0.06 | 0.06 | — |
| 6-[4-(N,N-diethoxy- | | | | | | | |
| carbonylmethyl)-3- | | | | | | | |
| bromophenyl]-s-triazine | | | | | | | |
| Phenothiazine- | — | 0.010 | 0.005 | 0.020 | 0.010 | 0.005 | 0.020 |
| Hydroquinone | 0.002 | — | — | — | — | — | — |
| monomethyl ether | | | | | | | |
| Additive 1 | — | 0.52 | — | — | 0.52 | — | — |
| Surfactant 1 | 0.044 | 0.060 | 0.070 | 0.050 | 0.060 | 0.070 | 0.050 |

TABLE 2
Unit: part by mass

| Colored photosensitive | Examples 9a to 15a | | | Example 16a | | |
|---|---|---|---|---|---|---|
| resin composition | R3a | G3a | B3a | R4a | G5a | B5a |
| K pigment dispersion 1 | — | — | — | — | — | — |
| R pigment dispersion 1 | 44 | — | — | 44 | — | — |
| (C.I.P.R.254) | | | | | | |
| R pigment dispersion 2 | 5.0 | — | — | 5.0 | — | — |
| (C.I.P.R.177) | | | | | | |
| G pigment dispersion 1 | — | 24 | — | — | — | — |
| (C.I.P.G.36) | | | | | | |
| G pigment dispersion 2 | — | — | — | — | 24 | — |
| (C.I.P.G.36) | | | | | | |
| Y pigment dispersion 1 | — | 13 | — | — | — | — |
| (C.I.P.Y.150) | | | | | | |
| Y pigment dispersion 2 | — | — | — | — | 13 | — |
| (C.I.P.Y.150) | | | | | | |
| B pigment dispersion 1 | — | — | 26 | — | — | — |
| (C.I.P.B. 15:6 + | | | | | | |
| C.I.P.V.23) | | | | | | |
| B pigment dispersion 2 | — | — | — | — | — | 8.0 |
| (C.I.P.B. 15:6) | | | | | | |
| B pigment dispersion 3 | — | — | — | — | — | 14 |
| (C.I.P.B. 15:6 + | | | | | | |
| C.I.P.V.23) | | | | | | |
| Propylene glycol monomethyl | 7.6 | 26 | 25 | 7.6 | 29 | 28 |
| ether acetate | | | | | | |
| Methyl ethyl ketone | 37 | 21 | 33 | 37 | 26 | 26 |
| Cyclohexanone | — | 1.1 | — | — | 1.3 | — |
| Binder 1 | — | — | — | — | 2.5 | — |
| Binder 2 | 0.7 | — | — | 0.7 | — | — |
| Binder 3 | — | — | 6.2 | — | — | 19 |
| DPHA solution | 3.8 | 3.7 | 4.1 | 3.8 | 3.5 | 4.2 |
| 2-Trichloromethyl-5-(p- | 0.12 | 0.13 | 0.16 | 0.12 | 0.1 | 0.17 |
| styrylmethyl)1,3,4- | | | | | | |
| oxadiazole | | | | | | |
| 2,4-Bis(trichloromethyl)- | 0.05 | 0.05 | — | 0.05 | 0.05 | — |
| 6-[4-(N,N-diethoxy- | | | | | | |
| carbonylmethyl)-3- | | | | | | |
| bromophenyl]-s-triazine | | | | | | |
| Phenothiazine- | 0.010 | 0.005 | 0.020 | 0.010 | 0.005 | 0.020 |
| Hydroquinone | — | — | — | — | — | — |
| monomethyl ether | | | | | | |
| Additive 1 | — | — | — | — | — | — |
| Surfactant 1 | 0.060 | 0.070 | 0.060 | 0.060 | 0.070 | 0.060 |

### —Formation of Black (K) Image—

An alkali-free glass substrate was washed with a rotation brush having a nylon bristle while a glass detergent solution (a 1 to 10 diluted solution (diluted with pure water) of T-SD1 (trade name, manufactured by Fuji Photo Film Co., Ltd.); containing a phosphate, a silicate, a nonionic surfactant, an anti-foaming agent, and a stabilizer,) regulated at 25° C. was blown with a shower for 20 seconds, washed with a pure water shower, and a silane coupling solution (N-β(aminoethyl) γ-aminopropyltrimethoxysilane 0.3% by mass aqueous solution, trade name: KBM603, manufactured by Shin-Etsu Chemical Co., Ltd.) was blown for 20 seconds with a shower, followed by washing with a pure water shower. This substrate was heated at 100° C. for 2 minutes with a substrate pre-heating apparatus. (Instead of T-SD1, T-SD2 may be used as a detergent solution.)

A protecting film for the photosensitive resin transferring material K1 was peeled, and this was laminated on the substrate heated at 100° C. using a laminator (Lamic II, manufactured by Hitachi Industries Co. Ltd.) at a rubber roller temperature of 130° C., a liner pressure of 100N/cm and a conveying rate of 2.2 m/min.

After the provisional support was peeled at the boundary face between the provisional support and the thermoplastic resin layer, in the state where the substrate and a mask (quartz exposure mask having image pattern) were stood vertical, a distance between an exposure mask surface and the photosensitive resin layer was set to be 200 μm, and pattern exposure was performed with a proximity-type exposing machine having a superhigh pressure mercury lamp (manufactured by Hitachi High-Tech Electronics Engineering Co., Ltd.) at an exposure amount of 70 mJ/cm².

Then, this was shower-developed with a triethanolamine-based developer (prepared as follows: stock solution prepared by mixing triethanolamine (30% by mass), propylene glycol, glycelol monostearate, polyoxyethylene sorbitan monostearate and stearyl ether (0.1% by mass, in total), and pure water (remainder) was diluted with pure water (1 to 12; the ratio such that 1 part by mass of the stock solution and 11 parts by mass of pure water was mixed) at 30° C. for 50 seconds at a flat nozzle pressure of 0.04 MPa, and the thermoplastic resin layer and an the intermediate layer were removed. Next, air was blown to the surface of substrate to remove moisture, followed by washing with pure water shower for 10 seconds. Then air was blown to the substrate to reduce water on the substrate.

Subsequently, this was shower developed at 29° C. for 30 seconds using a sodium carbonate-based developer (a 1 to 5 diluted solution (diluted with pure water) of T-CD1™, manufactured by Fuji Photo Film Co,. Ltd; containing 0.38 mole/litter of sodium bicarbonate, 0.47 mole/litter of sodium carbonate, 5% by mass of sodium dibutylnaphthalenesulfonate, anionic surfactant, anti-foaming agent, and stabilizer) with a cone-type nozzle at a pressure of 0.15 MPa, to develop the photosensitive resin layer to obtain a patterned image.

Subsequently, the residue was removed by showering at 33° C. for 20 seconds using a detergent (containing phosphate, silicate, nonionic surfactant, anti-foaming agent and stabilizer, trade name: T-SD1, manufactured by Fuji Photo Film Co., Ltd.) diluted with pure water (1 to 10) with a cone-type nozzle at a pressure of 0.02 MPa, and further rubbing with a rotation brush having a nylon bristle, to obtain a black (K) image. (As a detergent, T-SD2 may be used instead of T-SD1).

Thereafter, further, the substrate was post-exposed with light at 500 mJ/cm² with a superhigh pressure mercury lamp from both sides of the resin layer, and heat-treated at 220° C. for 15 minutes.

This substrate on which a K image was formed was washed with a brush as described above, washed with a pure water shower, conveyed to a substrate pre-heating apparatus without using a silane coupling solution.

### —Formation of Red (R) Pixel—

According to the same manner as that of the photosensitive resin transferring material K1, and using the photosensitive resin transferring material R1, a red (R) pixel was obtained on the substrate on which a black (K) pixel was formed. A light exposing amount was 40 mJ/cm², and development with a sodium carbonate-based developer was performed at 35° C. for 35 seconds.

A thickness of the photosensitive resin layer R1 was 2.0 μm, and coating amounts of pigments C.I.Pigment•Red 254 and C.I.Pigment•Red 177 were 0.88 and 0.22 g/m², respectively

This substrate on which a R pixel was formed was washed again with a brush as described above, washed with a pure water shower, and heated at 100° C. for 2 minutes with a substrate pre-heating apparatus without using a silane coupling solution.

### —Formation of Green (G) Pixel—

According to the same step as that of the photosensitive resin transferring material R1, and using the photosensitive resin transferring material G1, a green (G) pixel was obtained on the substrate on which the red (R) pixel was formed. A light exposure amount was 40 mJ/cm², and development with a sodium carbonate-based developer was performed at 34° C. for 45 seconds. A monochrome substrate for evaluation of contrast measurement was prepared by forming a green (G) colored layer on an alkali-free glass substrate in a same manner as in the formation of green (G) pixel.

A thickness of the photosensitive resin layer G1 was 2.0 μm, and coating amounts of pigments C.I.Pigment•Green 36 and C.I.Pigment•Yellow 150 were 1.12 and 0.48 g/m², respectively.

The substrate on which R and G images were formed was washed again with a brush as described above, washed with a pure water shower, and heated at 100° C. for 2 minutes with a substrate pre-heating apparatus without using a silane coupling solution.

### —Formation of Blue (B)—

According to the same step as that of to the photosensitive resin transferring material R1, and using the photosensitive resin transferring material B1, a blue (B) pixel was obtained on the substrate on which the red (R) pixel and the green pixel (G) were formed. A light exposure amount was 30 mJ/cm², and development with a sodium carbonate-based developer was performed at 36° C. for 410 seconds. A monochrome substrate for evaluation of contrast measurement was prepared by forming a blue (B) colored layer on an alkali-free glass substrate in a same manner as in the formation of blue (B) pixel.

A thickness of the photosensitive resin layer B1 was 2.0 μm, and coating amounts of pigments C.I.Pigment•Blue 15:6 and C.I.Pigment•Violet 23 were 0.63 and 0.07 g/m², respectively.

This substrate on which R, G and B pixels were formed was washed again with a brush as described above, washed with a pure water shower, and heated at 100° C. for 2 minutes with a substrate pre-heating apparatus without using a silane coupling solution.

This substrate on which R, G, and B pixels and K image were formed was baked at 240° C. for 50 minutes to obtain an objective color filter.

Herein, manufacturing of colored photosensitive resin compositions K1, R1, G1 and B1 described in Table 1 will be explained.

The colored photosensitive resin composition K1 was obtained by first weighing a K pigment dispersion 1 and propylene glycol monomethyl ether acetate at amounts described in Table 1, mixing them at a temperature of 24° C. (2° C.), stirring the mixture at 150 rpm for 10 minutes, then, weighing methyl ethyl ketone, a binder 1, hydroquinone monomethyl ether, a DPHA solution, 2,4-bis(trichloromethyl)-6-[4-(N,N-diethoxycarbonylmethylamino)-3-bromophenyl]-s-triazin e, and a surfactant 1, adding them in this order at a temperature of 25° C. (±2° C.), and stirring them at a temperature of 40° C. (±2° C.) and 150 rpm for 30 minutes.

Among a composition described in the formulation K1, a composition of the K pigment dispersion 1 was as follows:

| | | |
|---|---|---|
| Carbon black (trade name: NIPEX 35, manufactured by | 13.1 | parts |
| Degussa Japan) | | |
| N,N′-bis-(3-diethylaminopropyl)-5-{4-[2-oxo-1-(2- | 0.65 | part |
| oxo-2,3-dihydro-1H-benzimidazol-5-yl | | |
| carbamoyl)-propylazo]-benzoylamino}-isophthalamide | | |
| Polymer (random copolymer of benzyl methacrylate/ | 6.72 | parts |
| methacrylic acid = 72/28 mole ratio, weight average | | |
| molecular weight 37,000) | | |
| Propylene glycol monomethyl ether acetate | 79.53 | parts |

The colored photosensitive resin composition R1 was obtained by first weighing a R pigment dispersion 1, a R pigment dispersion 2, and propylene glycol monomethyl ether acetate at amounts described in Table 1 mixing them at a temperature of 24° C. (±2° C.), stirring the mixture at 150 rpm for 10 minutes, then, weighing methyl ethyl ketone, a binder 2, a DPHA solution, 2-trichloromethyl-5-(p styrylmethyl)-1,3,4-oxadiazole, 2,4-bis(trichloromethyl)-6-[4-(N,N-diethoxycarbonylmethylamino)-3-bromophenyl]-s-triazin e, and phenothiazine at amounts described in Table 1, adding them in this order at a temperature of 24° C. (+2° C.), stifling this at 150 rpm for 30 minutes, further, weighing an additive 1 and a surfactant 1 at an amount described in Table 1, adding this at a temperature of 24° C. (±2° C.), stirring the mixture at 30 rpm for 5 minutes, and filtering this with a nylon mesh #200.

Among a composition described in Table 1, a composition of the R pigment dispersion 1 was as follows:

| | | |
|---|---|---|
| C.I.P.R.254 (IRGAPHOR RED B-CF, manufactured by | 8 | parts |
| Ciba Specialty Chemicals) | | |
| N,N′-bis-(3-diethylaminopropyl)-5-{4-[2-oxo-1- | 0.8 | part |
| (2-oxo-2,3-dihydro-1H-benzimidazol-5-yl | | |
| carbamoyl)-propylazo]-benzoylamino}-isophthalamide | | |
| Polymer (random copolymer of benzyl methacrylate/ | 8 | parts |
| methacrylic acid = 72/28 mole ratio, weight | | |
| average molecular weight 37,000) | | |
| Propylene glycol monomethyl ether acetate | 83.2 | parts |

A composition of the R pigment dispersion 2 (manufactured by Fuji Film Arch) was as follows:

| | |
|---|---|
| C.I.P.R.177 (CROMOPHTAL RED A2B, manufactured by Ciba | 18 parts |
| Specialty Chemicals) | |
| Polymer (random copolymer of benzyl methacrylate/ | 12 parts |
| methacrylic acid = 72/28 mole ratio, weight | |
| average molecular weight 37,000) | |
| Propylene glycol monomethyl ether acetate | 70 parts |

The above composition was dispersed for 27 hours using a motor mill M-50 (manufactured by Aiger Japan) and zirconia beads having a diameter of 0.65 mm at a circumferential rate of 9 m/s to prepare a pigment dispersion composition. A number average particle diameter of a pigment at this time is shown in Table 3.

The colored photosensitive resin composition G1 was obtained by first weighing a G pigment dispersion 1, a Y pigment dispersion 1, and propylene glycol monomethyl ether acetate at amounts described in Table 1 mixing them at a temperature of 24° C. (±2° C.), stirring the mixture at 150 rpm for 10 minutes, then, weighing methyl ethyl ketone, cyclohexanone, a binder 1, a DPHA solution, 2-trichloromethyl-5-(p-styrylstyryl)-1,3,4-oxadiazole, 2,4-bis(trichloromethyl)-6-[4-(N,N-diethoxycarbonylmethylamino)-3-bromophenyl]-s-triazin e, and phenothiazine at amounts described in Table 1, adding them in this order at a temperature of 24° C. (±2° C.), stirring the mixture at 150 rpm for 30 minutes, further, weighing a surfactant 1 at an amount described in Table 1, adding this at a temperature of 24° C. (±2° C.), stirring the mixture at 30 rpm for 5 minutes, and filtering this with a nylon mesh #200.

Among the composition described in Table 1, a composition of the G pigment dispersion 1 was as follows:

| | |
|---|---|
| C.I.P.G.36 (Rionol Green 6YK, Toyo Ink Mfg, Co., Ltd.) | 14 parts |
| Polymer (random copolymer of benzyl methacrylate/ | 23 parts |
| methacrylic acid = 72/28 mole ratio, weight | |
| average molecular weight 37,000) | |
| N,N′-bis-(3-diethylaminopropyl)-5-{4-[2-oxo-1- | 1.4 parts |
| (2-oxo-2,3-dihydro-1H-benzimidazol-5-yl | |
| carbamoyl)propylazo]-benzoylamino}-isophthlamide | |
| Propylene glycol monomethyl ether acetate | 61.6 parts |

A composition of the Y pigment dispersion 1 was as follows:

| | |
|---|---|
| C.I.P.Y.150 (BAYPLAST YELLOW 5GN 01, Bayer Ltd.) | 15 parts |
| Polymer (random copolymer of benzyl methacrylate/ | 9 parts |
| methacrylic acid = 72/28 mole ratio, weight | |
| average molecular weight 37,000) | |
| N,N′-bis-(3-diethylaminopropyl)-5-{4-[2-oxo-1- | 1.5 parts |
| (2-oxo-2,3-dihydro-1H-benzimidazol-5-yl | |
| carbamoyl)-propylazo]-benzoylamino}-isophthalamide | |
| Propylene glycol monomethyl ether acetate | 74.5 parts |

The above composition was dispersed for 28 hours using a mortar mill M-50 (manufacture by Aiger Japan), and zirconia beads having a diameter of 0.65 mm at a circumferential rate of 9 m/s, to prepare a pigment dispersion composition. A number average particle diameter of a pigment at this time is shown in Table 3.

The colored photosensitive resin composition B1 was obtained by first weighing a B pigment dispersion 1, and propylene glycol monomethyl ether acetate at amounts described in Table 1, mixing them at a temperature of 24° C. (±2° C.), stirring the mixture at 150 rpm for 10 minutes, then, weighing methyl ethyl ketone, a binder 3, a DPHA solution, 2-trichloromethyl-5-(p-styrylstyryl)-1,3,4-oxadiazole, and phenothiazine, adding them in this order at a temperature of 25° C. (±2° C.), stirring the mixture at a temperature of 40° C. (+2° C.) and 150 rpm for 30 minutes, further, weighting a surfactant 1 at an amount described in Table 1, adding this at a temperature of 24° C. (±2° C.), stirring the mixture at 30 rpm for 5 minutes, and filtering this with a nylon mesh #200.

Among the composition described in Table 1, a composition of the B pigment dispersion 1 was as follows:

| | | |
|---|---|---|
| C.I.P.B.15:6 (Rionol Blue ES, manufactured by Toyo Ink | 11.28 | parts |
| Mfg, Ltd. | | |
| C.I.P.V.23 (Hostaperm Violet RL-NF, manufactured by | 0.72 | part |
| Clariant Japan) | | |
| EFKA-745 (manufactured by EFKA ADDITIVES B.V.) | 0.6 | parts |
| Disparon DA-725 (manufactured by Kusumoto Chemicals, | 0.75 | part |
| Ltd.) | | |
| Propylene glycol monomethyl ether acetate | 86.65 | parts |

The above composition was dispersed for 27 hours using a motor mill M-50 (manufactured by Aiger Japan) and zirconia beads having a diameter of 0.65 mm at a circumferential rate of 9 in/s to prepare a pigment dispersion composition. A number average particle diameter of a pigment at this time is shown in Table 3.

A composition of the binder 1 was as follows:

| | |
|---|---|
| Polymer (random copolymer of benzyl methacrylate/ | 27 parts |
| methacrylic acid = 78/22 mole ratio, | |
| weight average molecular weight 37,000) | |
| Propylene glycol monomethyl ether acetate | 73 parts |

A composition of the binder 2 was as follows:

| | |
|---|---|
| Polymer (random copolymer of benzyl methacrylate/methacrylic | 27 parts |
| acid/methyl methacrylate = 38/25/37 | |
| mole ratio, weight average molecular weight 38,000) | |
| Propylene glycol monomethyl ether acetate | 73 parts |

A composition of the binder 3 was as follows:

| | |
|---|---|
| Polymer (random copolymer of benzyl methacrylate/methacrylic | 27 parts |
| acid/methyl methacrylate = 36/22/42 | |
| mole ratio, weight average molecular weight 38,000) | |
| Propylene glycol monomethyl ether acetate | 73 parts |

A composition of the DPHA solution was as follows:

| | |
|---|---|
| Dipentaerythritol hexaacrylate (containing 500 ppm of | 76 parts |
| polymerization inhibitor MEHQ500 ppm, trade name: | |
| KAYARAD DPHA, manufactured by Nippon Kayaku Co., Ltd.) | |
| Propylene glycol monomethyl ether acetate | 24 parts |

A composition of the surfactant 1 (trade name: MEGAFACE F780F, manufactured by Dainippon Ink and Chemicals, Incorporated) was as follows:

| | |
|---|---|
| Copolymer of 40 parts of | 30 parts |
| C₆F₁₃CH₂CH₂OCOCH═CH₂, 55 parts of | |
| H(OCH(CH₃)CH₂)₇OCOCH═CH₂, | |
| and 5 parts of H(OCH₂CH₂)₇OCOCH═CH₂, weight average | |
| molecular weight 30,000 | |
| Methyl ethyl ketone 30% solution | 70 parts |

### Examples 2 to 7

### Comparative Examples 1 and 2

According to the same formulations and preparing method as those of Example 1, and by changing a dispersing time to a time described in Table 3, objective color filters were manufactured.

### Example 8

According to the same manner as that of Example 1 except that colored photosensitive resin compositions G1 and B1 used in Example 1 were changed to G2 and B2 described in the following Table 1, respectively, objective color filters were manufactured.

The colored photosensitive resin composition G2 was obtained by first weighing a G pigment dispersion 2, a Y pigment dispersion 2, and propylene glycol monomethyl ether acetate at amounts described in Table 1, mixing them at a temperature of 24° C. (+2° C.), stirring the mixture at 150 rpm for 10 minutes, then, weighing methyl ethyl ketone, cyclohexanone, a binder 1, a DPHA solution, 2-trichloromethyl-5-(p-styrylstyryl)-1,3,4-oxadiazole, 2,4-bis(trichloromethyl)-6-[4-(N,N-diethoxylcarbonylmethylamino)-3-bromophenyl]-s-triazin e, and phenothiazine at amounts described in Table 1, adding them in this order at a temperature of 24° C. (+2° C.), stirring the mixture at 150 rpm for 30 minutes, further, weighting a surfactant 1 at an amount described in Table 1, adding this at a temperature of 24° C. (±2° C.), stirring the mixture at 30 rpm for 5 minutes, and filtering this with a nylon mesh #200.

Among the composition described in Table 1, as a composition of the G pigment dispersion 2, GT-2 (trade name, manufactured by Fuji Film Electronics Materials) was used.

As a composition of the Y pigment dispersion 2, CF Yellow EX3393 (trade name, manufactured by Mikuni Color Ltd.) was used.

The colored photosensitive composition B2 was obtained by first weighing a B pigment dispersion 2, a B pigment dispersion 3, and propylene glycol monomethyl ether acetate at amounts described in Table 1 mixing them at a temperature of 24° C. (±2° C.), stirring the mixture at 150 rpm for 10 minutes, then, weighing methyl ethyl ketone, a binder 3, a DPHA solution, 2-trichloromethyl-5-(p-styrylstyryl)-1,3,4-oxadiazole, 2,4-bis(trichloromethyl)-6-[4-(N,N-diethoxycarbonylmethylamino)-3-bromophenyl]-s-triazin e, and phenothiazine at amounts described in Table 1, adding them in this order at a temperature of 25° C. (2° C.), stirring the mixture at a temperature of 40° C. (2° C.) and 150 rpm for 30 minutes, further, weighing a surfactant 1 at an amount described in Table 1, adding this at a temperature of 24° C. (+2° C.), stirring the mixture at 30 rpm for 5 minutes, and filtering this with a nylon mesh #200.

Among the composition described in Table 1, as a composition of the B pigment dispersion 2, CF Blue EX3357 (trade name, manufactured by Mikuni Color Ltd.) was used.

As a composition of the B pigment dispersion 3, CF Blue EX3383(trade name, manufactured by Mikuni Color Ltd.) was used.

### Example 9a

### Manufacturing of Color Filter (Manufacturing by Coating Using Slit-Like Nozzle)

### —Formation of Black (K) Image—

An alkali-free glass substrate was washed with a UV washing apparatus, brush-washed using a detergent, and further ultrasound-washed with ultrapure water. The substrate was heat-treated at 120° C. for 3 minutes to stabilize the surface state.

The substrate was cooled, a temperature was regulated at 23° C., and the colored photosensitive resin composition K1 consisting of a composition described in Table 1 was coated with a glass substrate coater having, a slit-like nozzle (manufactured by Hirata Corporation). Subsequently, a part of a solvent was dried for 30 seconds with a vacuum drying apparatus (trade name: VCD, manufactured by Tokyo Ohka Kogyo Co., Ltd.) to lose flowability of a coated layer, and this was pre-baked at 120° C. for 3 minutes to obtain a photosensitive resin layer K1 having a Thickness of 2.4 μm.

In the state where a substrate and a mask (quartz exposure mask having image pattern) were stood vertical, a distance between an exposure mask surface and the photosensitive resin layer was set to be 200 μm, and pattern exposure was performed with a proximity-type exposing machine having a ultrahigh-pressure mercury lamp (manufactured by Hitachi Hi-Tech Electronics Engineering Co., Ltd.) at a light exposure amount of 300 mJ/cm².

Then, pure water was sprayed with a shower nozzle to uniformly wet a surface of the photosensitive resin layer K1, this was shower-developed with a KOH-based developer (containing KOH, and nonionic surfactant, trade name: CDK-1, manufacture by Fuji Film Electomaterials) at 23° C. for 80 seconds at a flat nozzle pressure of 0.04 MPa, to obtain a patterning image. Subsequently, ultrapure water was sprayed with a ultrahigh pressure washing nozzle at a pressure of 9.8 MPa to remove the residue, and ultrapure water was blown to the both surfaces of the substrate to remove developer and the dissolved photosensitive resin layer, followed by removing moisture with an air knife, to obtain a black (K) image. Subsequently, this was heat-treated at 220° C. for 30 minutes.

### —Formation of Ted (R) Pixel—

According to the same step as that of formation of the black (K) image, and using the colored photosensitive resin composition R3a consisting of a composition described in the above Table 2, a heat-treated red (R) pixel was formed on the substrate on which the black (K) image was formed.

A thickness of the photosensitive resin layer R3a was 10.6 μm, and coating amounts of C.I.Pigment•Red 254 and C.I.Pigment•Red177 were 0.88 g/m², and 0.22 g/m², respectively.

A monochrome substrate for evaluation of contrast measurement was prepared by forming a red (R) colored layer on an alkali-free glass substrate in a same manner as in the formation of green (R) pixel.

### —Formation of Green (G) Pixel—

According to the same step as that of formation of the black (K) image, and using the colored photosensitive resin composition G3a consisting of a composition described in the above Table 2, heat-treated green (G) pixel was formed on the substrate on which the black (K) image and the red (R) pixel were formed.

A thickness of the photosensitive resin layer G3a was 10.6 μm, and coating amounts of C.I.Pigment•Green 36 and C.I.Pigment•Yellow 150 were 1.12 g/m², and 0.48 g/m², respectively.

A monochrome substrate for evaluation of contrast measurement was prepared by forming a green (G) colored layer on an alkali-free substrate in a same manner as in the formation of green (G) pixel.

### —Formation of Blue (B) Pixel—

According to the same step as that of formation of the black (K) image, and using the following colored photosensitive resin composition B3a consisting of a composition described in the above Table 2, a heat-heated blue (B) pixel was formed on the substrate on which the black (K) image and red (R) and green (G) pixels were formed.

A thickness of the photosensitive resin layer G3a was 1.6 μm, and coating amounts of C.I.Pigment•Blue 15:6 and C.I.Pigment•Violet. 23 were 0.63 g/m², and 0.07 g/m², respectively.

A monochrome substrate for evaluation of contrast measurement was prepared by forming a blue (B) colored layer on an alkali-free substrate in a same manner as in the formation of green (B) pixel.

The colored photosensitive resin compositions R3a, G3a and B3a were prepared in accordance with the preparation method of the colored photosensitive resin compositions R1, G1, and B1 respectively.

The dispersing time and number average particle diameter for the colored photosensitive resin compositions R3a, G3a, and B3a are shown in Table 4.

### Examples 10a to 15a

Objective color filters were prepared in the same manner as in Example 9a and using the same formulation as that of Example 9a, except for changing dispersing time as described in Table 4.

### Example 16a

An objective color filter was prepared in the same manner as in Example 9a except for changing the colored photosensitive resin compositions G3a and B3a to the colored photosensitive resin composition G4a and B4a respectively.

The colored resin compositions G4a and B4a were prepared in accordance with the preparation method of the colored photosensitive resin composition G2 and B2 respectively. Assessment

### —Measurement of Contrast—

A contrast of each colored pixel constituting the color filter obtained from the forgoing was measured by the following measuring method, and a difference in contrasts of the respective colored pixels was calculated. Results are shown in Tables 3 and 4

### (Method of Measuring Contrast)

A three wavelength cold cathode tube light source (FWL18EX-N, manufactured by Toshiba Lighting and Technology Corporation) provided with a diffusion substrate was used as a backlight, a color filter or a monochrome substrate was arranged between two polarizing plates (trade name: G1220DUN, manufactured by Nitto Denko Corporation), and a contrast was obtained by dividing a Y value of a chromaticity of light which passes when polarizing plates are arranged at parallel nicol by a Y value of a chromaticity of light which passes when arranged at crossed nicol. For measuring a chromaticity, a color luminance meter (trade name: BM-5, manufactured by TOPCON Corporation) was used.

The two polarizing plates, color filter and color luminance meter were arranged as follows. One of the polarizing plates was placed at 13 mm from the backlight. A cylinder having a diameter of II mm and a length of 20 mm was placed at 40 to 60 mm from the backlight. The light having passed through the cylinder was applied to the measurement sample placed at 65 mm from the backlight. The light was measured via the other polarizing plate placed at 100 mm from the backlight by the color luminance meter placed at 400 mm from the backlight. The measurement angle of the color luminance meter was 2°. The light dose of the backlight was set such that the luminance measured when no sample was placed and two polarizing plates were arranged at parallel nicol was 1280 cd/m².

### [Manufacturing and Assessment of Liquid Crystal Display Device]

A transparent electrode layer of ITO (Indium Tin Oxide) was formed on pixels of each of the color filters manufactured in Examples 1 to 8 and 9a to 16a and Comparative Examples 1 and 2 and, further, an oriented film of polyimide was provided thereon. A sealing agent of an epoxy resin containing space r particles was printed on a position corresponding to an external frame of a black matrix provided at a periphery of pixel group of the color filter, and a color filter substrate and a counter substrate were laminated to each other at a pressure of 10 kg/cm. Then, the laminated glass substrates were heat-treated at 150° C. for 90 minutes to cure the sealing agent, to obtain a laminate of two glass substrates. This glass substrate laminate was degassed under vacuum and, thereafter, a pressure was returned to an atmospheric pressure, a liquid crystal was; injected into a gap between two glass substrates to obtain a liquid crystal cell.

### —Measurement of Black Display—

Each of liquid crystal display panels using color filters manufactured in Examples 1 to 8 and 9a to 16a and Comparative Examples 1 and 2 was black-displayed, a chromaticity at this time was measured, an achromatic color chromaticity was defined as (x,y,Y=0.333, 0.333, 0.08), and a color difference from this color was calculated. Results are shown in Tables 3 and 4. A chromaticity at black display was measured by the following method. A three wavelength cold cathode tube light source was used as a backlight, two polarizing plates (trade name: G1220DUN, manufactured by Nitto Denko Corporation) were arranged at a crossed nicol, a color filter was arranged between the polarizing plates, and a chromaticity of leaked light was measured using a color luminance meter (trade name: BM-5, manufactured by TOPCON Corporation). A color difference from an achromatic point is preferably 5 or less. When the difference exceeds 5, since black display is colored, this is not preferable.

### —Method of Measuring Vividness—

Vividness when solid colors of red, green and blue were displayed on a background at black display of each of liquid crystal display panels using color filters manufactured in Examples 1 to 8 and 9a to 16a and Comparative Examples 1 and 2 was organoleptically assessed by 50 subjects. Assessment was performed by five stages in a higher vividness order, and an average was adopted as an assessment value.

Results of Examples 1 to 8 and Comparative Examples 1 and 2 are shown in Table 3. Results of Examples 9a to 16a are shown in Table 4. In Tables 3 and 4, A indicates not lower than 4 and not higher than 5, B indicates not lower than 3 and less than 4, and C indicates less than 3.

TABLE 3

| Colored | | | | | | | | | | | | | | | |
|---|---|---|---|---|---|---|---|---|---|---|---|---|---|---|---|
| photosensitive | Example 1 | | | Example 2 | | | Example 3 | | | Example 4 | | | Example 5 | | |
| resin composition | R1 | G1 | B1 | R1 | G1 | B1 | R1 | G1 | B1 | R1 | G1 | B1 | R1 | G1 | B1 |
| Dispersing time | 27 | 28 | 27 | 21 | 22 | 23 | 12 | 13 | 11 | 12 | 13 | 11 | 23 | 22 | 22 |
| [hr] | | | | | | | | | | | | | | | |
| Number average | 52 | 57 | 54 | 60 | 70 | 64 | 82 | 88 | 87 | 76 | 91 | 90 | 59 | 73 | 71 |
| particle diameter | | | | | | | | | | | | | | | |
| [nm] | | | | | | | | | | | | | | | |
| Contrast | 3400 | 3430 | 3500 | 3002 | 3153 | 3312 | 2013 | 2233 | 2515 | 2105 | 2120 | 2300 | 3012 | 3052 | 3098 |
| Contrast | 100 | | | 310 | | | 502 | | | 195 | | | 86 | | |
| difference | | | | | | | | | | | | | | | |
| Color difference | 4.0 | | | 4.6 | | | 4.8 | | | 4.1 | | | 4.0 | | |
| from achromatic | | | | | | | | | | | | | | | |
| point | | | | | | | | | | | | | | | |
| Vividness | A | | | A | | | B | | | B | | | A | | |
| Colored | | | | | | | | | | Comparative | | | Comparative | | |
| photosensitive | Example 6 | | | Example 7 | | | Example 8 | | | Example 1 | | | Example 2 | | |
| resin composition | R1 | G1 | B1 | R1 | G1 | B1 | R2 | G2 | B2 | R1 | G1 | B1 | R1 | G1 | B1 |
| Dispersing time | 23 | 23 | 23 | 28 | 29 | 29 | 33 | | | 9 | 8 | 9 | 12 | 14 | 12 |
| [hr] | | | | | | | | | | | | | | | |
| Number average | 56 | 58 | 52 | 54 | 59 | 51 | 51 | 57 | 55 | 105 | 103 | 110 | 81 | 89 | 89 |
| particle diameter | | | | | | | | | | | | | | | |
| [nm] | | | | | | | | | | | | | | | |
| Contrast | 3188 | 3412 | 3589 | 3308 | 3312 | 3612 | 3402 | 3427 | 3493 | 1350 | 1702 | 1780 | 2053 | 2512 | 2687 |

| | | | | | |
|---|---|---|---|---|---|
| Contrast | 401 | 304 | 91 | 430 | 634 |
| difference | | | | | |
| Color difference | 4.7 | 4.6 | 4.0 | 4.7 | 5.5 |
| from achromatic | | | | | |
| point | | | | | |
| Vividness | A | A | A | C | B |

TABLE 4

| Colored | | | | | | | | | | | | |
|---|---|---|---|---|---|---|---|---|---|---|---|---|
| photosensitive | Example 9a | | | Example 10a | | | Example 11a | | | Example 12a | | |
| resin composition | R3a | G3a | B31 | R3a | G3a | B3a | R3a | G3a | B3a | R3a | G3a | B3a |
| Dispersing time | 27 | 28 | 27 | 21 | 22 | 23 | 12 | 13 | 11 | 12 | 13 | 11 |
| [hr] | | | | | | | | | | | | |
| Number average | 52 | 57 | 54 | 60 | 70 | 64 | 82 | 88 | 87 | 76 | 91 | 90 |
| particle diameter | | | | | | | | | | | | |
| [nm] | | | | | | | | | | | | |
| Contrast | 3400 | 3430 | 3500 | 3002 | 3153 | 3312 | 2013 | 2233 | 2515 | 2105 | 2120 | 2300 |
| Contrast | 100 | | | 310 | | | 502 | | | 195 | | |
| difference | | | | | | | | | | | | |
| Color difference | 4.0 | | | 4.6 | | | 4.8 | | | 4.1 | | |
| from achromatic | | | | | | | | | | | | |
| point | | | | | | | | | | | | |
| Vividness | A | | | A | | | B | | | B | | |
| Colored | | | | | | | | | | | | |
| photosensitive | Example 13a | | | Example 14a | | | Example 15a | | | Example 16a | | |
| resin composition | R3a | G3a | B3a | R3a | G3a | B3a | R3a | G3a | B3a | R4a | G4a | B4a |
| Dispersing time | 23 | 22 | 22 | 23 | 23 | 23 | 28 | 29 | 29 | 33 | | |
| [hr] | | | | | | | | | | | | |
| Number average | 59 | 73 | 71 | 56 | 58 | 52 | 54 | 59 | 51 | 51 | 57 | 55 |
| particle diameter | | | | | | | | | | | | |
| [nm] | | | | | | | | | | | | |
| Contrast | 3012 | 3052 | 3098 | 3188 | 3412 | 3589 | 3308 | 3312 | 3612 | 3402 | 3427 | 3493 |

| | | | | |
|---|---|---|---|---|
| Contrast | 86 | 401 | 304 | 91 |
| difference | | | | |
| Color difference | 4.0 | 4.7 | 4.6 | 4.0 |
| from achromatic | | | | |
| point | | | | |
| Vividness | A | A | A | A |

From Tables 3 and 4, a color filter of the invention in which the contrast of each colored pixel is not lower than 2000 and, among colored pixels of three colors, the difference between the contrast of the colored pixel having the lowest contrast and the contrast of the colored pixel having the highest contrast is not more than 600, has a high contrast of each pixel, displays a vivid image, has a balance of contrasts of respective pixels of RCB, and is excellent in black display property. On the other hand, a color filter of Comparative Example 1 in which the contrast of each colored pixel is less than 2000, has a low contrast of each pixel, and exhibits an image lacking vividness, and a color filter of Comparative Example 2 in which, among colored pixels of three colors, the difference between the contrast of the colored pixel having the lowest contrast and the contrast of the colored pixel having the highest contrast exceeds 600, has no balance of contrasts of respective pixels of RGB, and since a contrast of a red colored pixel is low, a color is shifted to a reddish direction, and black display property is inferior.

### Examples 9 to 28 and Comparative Examples 3 to 10

### Examples 9 and 25

### Manufacturing of Color Filter (Manufacturing by Coating Using Slit-Like Nozzle)

### —Formation of Black (K) Image—

An alkali-free glass substrate was washed with a UV washing apparatus, brush-washed using a detergent, and further ultrasound-washed with ultrapure water. The substrate was heat-treated at 120° C. for 2 minutes to stabilize the surface state.

The substrate was cooled, a temperature was regulated at 23° C., and a colored photosensitive resin composition K2 consisting of a composition described in the following Table 5 was coated with a glass substrates coater having a slit-like nozzle (trade name: MH-1600, manufactured by FAS Japan). Subsequently, a part of a solvent was dried for 30 seconds with a vacuum drying apparatus (trade name: VCD, manufactured by Tokyo Ohka Kogyo Co., Ltd.) to lose flowability of a coated layer, an unnecessary coating solution at a periphery of a substrate was removed with EBR (Edge Bead Rim bar), and this was pre-baked at 120° C. for 3 minutes to obtain a photosensitive resin layer K2 having a thickness of 2.4 μm.

In the state where a substrate and a mask (quartz exposure mask having image pattern) were stood vertical, a distance between an exposure mask surface and the photosensitive resin layer was set to be 200 μm, and pattern exposure was performed with a proximity-type exposing machine having a ultrahigh-pressure mercury lamp (manufactured by Hitachi Hi-Tech Electronics Engineering Co., Ltd.) at a light exposure amount of 300 mJ/cm².

Then, pure water was sprayed with a shower nozzle to uniformly wet a surface of the photosensitive resin layer K2, this was shower-developed with a KOH-based developer (containing KOH, and nonionic surfactant, trade name: CDK-1, manufacture by Fuji Film Arch) diluted 100-fold with pure water at 23° C. for 80 seconds at a flat nozzle pressure of 0.04 MPa, to obtain a patterning image. Subsequently, ultrapure water was sprayed with a ultrahigh pressure washing nozzle at a pressure of 9.8 MPa to remove the residue, to obtain a black (K) image. Subsequently, this was heat-treated at 220° C. for 30 minutes.

TABLE 5

| Colored | | | | | Examples 10 to 16 | | |
|---|---|---|---|---|---|---|---|
| photosensitive | Examples 9 to 28 | | | | Comparative | | |
| resin | Comparative Examples 3 to 10 | Examples 9, 25, 27 | | | Examples 3 to 6 | | |
| composition | K2 | R3 | G3 | B3 | R4 | G4 | B4 |
| K pigment | 25 | — | — | — | — | — | — |
| dispersion 2 | | | | | | | |
| R pigment | — | 44 | — | — | 44 | — | — |
| dispersion 3 | | | | | | | |
| (C.I.P.R.254) | | | | | | | |
| R pigment | — | 5.0 | — | — | 5.0 | — | — |
| dispersion 4 | | | | | | | |
| (C.I.P.R.177) | | | | | | | |
| G pigment | — | — | 24 | — | — | — | — |
| dispersion 3 | | | | | | | |
| (C.I.P.G.36) | | | | | | | |
| G pigment | — | — | — | — | — | 30 | — |
| dispersion 4 | | | | | | | |
| (C.I.P.G.36) | | | | | | | |
| Y pigment | — | — | 12.5 | — | — | — | — |
| dispersion 3 | | | | | | | |
| (C.I.P.Y.150) | | | | | | | |
| Y pigment | — | — | — | — | — | 12 | — |
| dispersion 4 | | | | | | | |
| (C.I.P.Y.150) | | | | | | | |
| B pigment | — | — | — | 8.0 | — | — | — |
| dispersion 4 | | | | | | | |
| (C.I.P.B.15:6 + | | | | | | | |
| C.I.P.V.23) | | | | | | | |
| B pigment | — | — | — | 14.4 | — | — | — |
| dispersion 5 | | | | | | | |
| (C.I.P.B.15:6) | | | | | | | |
| B pigment | — | — | — | — | — | — | 27 |
| dispersion 6 | | | | | | | |
| (C.I.P.B.15:6 + | | | | | | | |
| C.I.P.V.23) | | | | | | | |
| Propylene glycol | 8.0 | 7.6 | 29 | 28 | 7.6 | 17 | 27 |
| monomethyl | | | | | | | |
| ether acetate | | | | | | | |
| Methyl ether | 53 | 37 | 26 | 41 | 37 | 26 | 35 |
| ketone | | | | | | | |
| Cyclohexanone | | | 1.3 | — | — | 10 | — |
| Binder 4 | 9.1 | | 2.5 | — | — | — | — |
| Binder 5 | — | 0.7 | — | — | 0.7 | — | — |
| Binder 6 | — | | — | 19 | — | — | 6.4 |
| DPHA solution | 4.2 | 3.8 | 3.5 | 4.2 | 4.0 | 3.8 | 4.2 |
| 2-Trichloro- | — | 0.12 | 0.1 | 0.17 | 0.12 | 0.1 | 0.16 |
| methyl-5-(p- | | | | | | | |
| styrylmethyl)1, | | | | | | | |
| 3,4-oxadiazole | | | | | | | |
| 2,4-Bis(trichloro | 0.2 | 0.050 | 0.1 | — | 0.052 | 0.1 | — |
| methyl)-6-[4-(N, | | | | | | | |
| N-diethoxy- | | | | | | | |
| carbonylmethyl)- | | | | | | | |
| 3-bromophenyl]- | | | | | | | |
| s-triazine | | | | | | | |
| Phenothiazine | — | 0.010 | 0.005 | 0.020 | 0.010 | 0.005 | 0.021 |
| Hydroquinone | 0.002 | — | — | — | — | — | — |
| monomethyl | | | | | | | |
| ether | | | | | | | |
| ED152 | — | — | — | — | — | — | — |
| Surfactant 2 | 0.044 | 0.060 | 0.070 | 0.060 | 0.060 | 0.07 | 0.05 |

unit: parts by mass

TABLE 6

| | | | | Examples 18 to 24 | | |
|---|---|---|---|---|---|---|
| | | | | Comparative | | |
| Colored photosensitive | Examples 17, 26, 28 | | | Examples 7 to 10 | | |
| resin composition | R5 | G5 | B5 | R6 | G6 | B6 |
| K pigment dispersion 2 | — | — | — | — | — | — |
| R pigment dispersion 3 | 44 | — | — | 44 | — | — |
| (C.I.P.R.254) | | | | | | |
| R pigment dispersion 4 | 5.0 | — | — | 5.0 | — | — |
| (C.I.P.R.177) | | | | | | |
| G pigment dispersion 3 | — | 24 | — | — | — | — |
| (C.I.P.G.36) | | | | | | |
| G pigment dispersion 4 | — | — | — | — | 30 | — |
| (C.I.P.G.36) | | | | | | |
| Y pigment dispersion 3 | — | 13 | — | — | — | — |
| (C.I.P.Y.150) | | | | | | |
| Y pigment dispersion 4 | — | — | — | — | 12 | — |
| (C.I.P.Y.150) | | | | | | |
| B pigment dispersion 4 | — | — | 7.2 | — | — | — |
| (C.I.P.B.15:6 + | | | | | | |
| C.I.P.V.23) | | | | | | |
| B pigment dispersion 5 | — | — | — | — | — | — |
| (C.I.P.B.15:6) | | | | | | |
| B pigment dispersion 6 | — | — | — | — | — | 27 |
| (C.I.P.B.15:6 + | | | | | | |
| C.I.P.V.23) | | | | | | |
| Propylene glycol monomethyl ether | 7.6 | 29 | 23 | 7.6 | 17 | 27 |
| acetate | | | | | | |
| Methyl ether ketone | 37 | 26 | 35 | 37 | 26 | 35 |
| Cyclohexanone | — | 1.3 | — | — | 10 | — |
| Binder 4 | — | 3 | — | — | — | — |
| Binder 5 | 0.8 | — | — | 0.8 | — | — |
| Binder 6 | — | — | 17 | — | — | 6.7 |
| DPHA solution | 4.4 | 4.3 | 3.8 | 4.4 | 4.4 | 4.4 |
| 2-Trichloro- | 0.14 | 0.15 | 0.15 | 0.14 | 0.15 | 0.17 |
| methyl-5-(p- | | | | | | |
| styrylmethyl)1,3, | | | | | | |
| 4-oxadiazole | | | | | | |
| 2,4-Bis(trichloromethyl)- | 0.06 | 0.06 | — | 0.06 | 0.06 | — |
| 6-[4-(N,N-diethoxy- | | | | | | |
| carbonylmethyl)-3-bromophenyl]- | | | | | | |
| s-triazine | | | | | | |
| Phenothiazine | 0.01 | 0.005 | 0.02 | 0.01 | 0.005 | 0.021 |
| Hydroquinone monomethyl ether | — | — | — | — | — | — |
| ED152 | 0.52 | — | — | 0.52 | — | — |
| Surfactant 2 | 0.06 | 0.07 | 0.05 | 0.06 | 0.07 | 0.05 |

unit: parts by mass

### —Formation of Red (R) Pixel—

According to the same step as that of formation of the black (K) image, and using the following colored photosensitive resin composition R3 consisting of a composition described in the above Table 5, a heat-treated red (R) pixel was formed on the substrate on which the black (K) image was formed, and a red (R) pattern of a 25×25 μm square was formed on the black (K) image. A light exposure amount was 150 mJ/cm², and development with a sodium carbonate-based developer was performed at 23° C. for 60 seconds.

A thickness of the formed red (R) pixel was 1.6 μm, and coating amounts of C.I.P.R.254 and C.I.P.R.177 were 0.88V/m², and 0.22 g/m², respectively.

### —Formation of Green (G) Pixel—

According to the same step as that of formation of the black (K) image, and using the following colored photosensitive resin composition G3 consisting of a composition described in the above Table 5, heat-treated green (G) pixel was formed on the substrate on which the black (K) image and the red (R) pixel were formed, and a green (G) pattern was formed on a base of a spacer formed by the black (K) image and red (R) pattern. A light exposure amount was 150 mJ/cm², and development with a sodium carbonate-based developer was performed at 23° C. for 60 seconds.

A thickness of the formed green (G) pixel was 1.6 μm, and coating amounts of C.I.P.G36 and C.I.P.Y.150 were 1.12 g/m², and 0.48 g/m², respectively.

### —Formation of Blue (B) Pixel—

According to the same step as that of formation of the black (K) image, and using the following colored photosensitive resin composition B3 consisting of a composition described in the above Table 5, a heat-treated blue (B) pixel was formed on the substrate on which the black (K) image, and the red (R) and green (G) pixels were formed, and a blue (B) pattern was formed on a base of a spacer formed by the black (K) image, and red (R) and green (G) patterns, to obtain an objective color filter. A light exposure amount was 150 mJ/cm², and development with a sodium carbonate-based developer was performed at 23° C. for 60 seconds.

A thickness of the formed blue (B) pixel was 1.6 μm, and coating amounts of C.I.P.B.15:6 and C.I.P.V. 23 were 0.63 g/m², and 0.07 g/m², respectively.

Herein, preparation of colored photosensitive resin compositions K2, R3, G3, and B3 described in the above Table Swill be explained.

The colored photosensitive resin composition K2 was obtained by first weighing a K pigment dispersion 2, and propylene glycol monomethyl ether acetate at amounts described in Table 5, mixing them at a temperature of 24° C. (±2° C.), stirring the mixture at 150 rpm for 10 minutes, then, weighing methyl ethyl ketone, a binder 1, hydroquinone monomethyl ether, a DPHA solution, 2,4-bis(trichloromethyl)-6-[4-(N, N-diethoxycarbonylmethyl)-3-bromophenyl]-s-triazine, and a surfactant 2 at amounts described in Table 5, adding them in this order at a temperature of 25° C. (±2° C.), and stirring the mixture at a temperature of 40° C. (±2° C.) and 150 rpm for 30 minutes.

Among the composition described in Tables 5 and 6, a composition of the K pigment dispersion 2 was as follows:

| | |
|---|---|
| Carbon black (trade name: Special Black 250, | 13.1 parts |
| manufactured by Degussa) | |
| 5-[3-oxo-2-[4-[3,5-bis(3- | 0.65 parts |
| diethylaminopropylaminocarbonyl)phenyl]amino- | |
| carbonyl]phenylazo]-butyroylaminobenzimidazolone | |
| Polymer (random copolymer of benzyl | 6.72 parts |
| methacrylate/methacrylic acid = 72/28 mole ratio, | |
| weight average molecular weight 37,000) | |
| Propylene glycol monomethyl ether acetate | 79.53 parts |

a composition of the binder 4 was as follows:

| | |
|---|---|
| Polymer (random copolymer of benzyl | 27 parts |
| methacrylate/methacrylic acid = 78/22 mole ratio, | |
| weight average molecular weight 40,000) | |
| Propylene glycol monomethyl ether acetate | 73 parts |
| a composition of the DPHA solution was as follows: | |
| Dipentaerythritol hexaacrylate (containing | 76 parts |
| polymerization inhibitor MEHQ 500 ppm, trade | |
| name: KAYARAD DPHA, manufactured by | |
| Nippon Kayaku Co., Ltd.) | |
| Propylene glycol monomethyl ether | 24 parts |

a composition of the surfactant 2 was as follows:

| | |
|---|---|
| Copolymer of C₆F₁₃CH₂CH₂OCOCH═CH₂: | 30 parts |
| 40 parts, H(O(CH₃)CHCH₂)₇OCOCH═CH₂: 55 | |
| parts and H(OCH₂CH₂)₇OCOCH═CH₂: | |
| 5 parts, weight average molecular weight 30,000 | |
| Methyl isobutyl ketone | 70 parts |

The colored photosensitive resin composition R3 was obtained by first weighing a R pigment dispersion 3, a R pigment dispersion 4, and propylene glycol monomethyl ether acetate at amounts described in Table 5, mixing them at a temperature of 24° C. (+2° C.), stirring the mixture at 150 rpm for 10 minutes, thien, weighing methyl ethyl ketone, a binder 2, a DPHA solution, 2-trichloromethyl-5-(p-styrylmethyl)-1,3,4-oxadiazole, 2,4-bis(trichloromethyl)-6-[4-(N,N-diethoxycarbonylmethyl)-3-bromophenyl]-s-triazine, and phenothiazine at amounts described in Table 5, adding them in this order at a temperature of 24° C. (+2° C.), stirring the mixture 150 rpm for 30 minutes, further, weighing a surfactant 2 at an amount described in Table 5, adding it at a temperature of 24° C. (±2° C.) stirring the mixture at 30 rpm for 30 minutes, and filtering this, with a nylon mesh #200.

Among the composition described in Tables 5 and 6, a composition of the R pigment dispersion 3 was as follows:

| | |
|---|---|
| C.I.Pigment.Red 254 | 8.0 parts |
| 5-[3-oxo-2-[4-[3,5-bis(3- | 0.8 part |
| diethylaminopropylaminocarbonyl)phenyl]amino- | |
| carbonyl]phenylazo]butyroylaminobenzimidazolone | |
| Polymer (random copolymer of benzyl | 8.0 parts |
| methacrylate/methacrylic acid = 72/28 mole ratio, | |
| weight average molecular weight 37,000) | |
| Propylene glycol monomethyl ether acetate | 83.2 parts |

a composition of the R pigment dispersion 4 was as follows:

| | |
|---|---|
| C.I.Pigment.Red 177 | 18 parts |
| Polymer (random copolymer of benzyl | 12 parts |
| methacrylate/methacrylic acid = 72/28 mole ratio, | |
| weight average molecular weight 37,000) | |
| Propylene glycol monomethyl ether acetate | 70 parts |
| a composition of the binder 5 was as follows: | |
| Random copolymer of benzyl methacrylate/methacrylic | 27 parts |
| acid/methyl methacrylate = 38/25/37 | |
| mole ratio, weight average molecular weight 30,000 | |
| Propylene glycol monomethyl ether acetate | 73 parts |

The colored photosensitive resin composition G3 was obtained by first weighing a G pigment dispersion 3, a Y pigment dispersion 3, and propylene glycol monomethyl ether acetate at amounts described in Table 5, mixing them at a temperature of 24° C. (±2° C.), stirring the mixture at 150 rpm for 10 minutes, then, weighing methyl ether ketone, cyclohexanone, a binder 5, a DPHA solution, 2-trichloromethyl-5-(p-styrylmethyl)-1,3,4-oxadiazole,
2,4-bis(trichloromethyl)-6-[4-(N,N-diethoxycarbonylmethyl)-3-bromophenyl]-s-triazine, and phenothiazine at amounts described in Table 5, adding them in this order at a temperature 24° C. (2° C.), stirring the mixture at 150 rpm for 30 minutes, further, weighing a surfactant 2 at an amount described in Table 5, adding it at a temperature of 24° C. (±2° C.), stirring the mixture at 30 rpm for 5 minutes, and filtering this with a nylon mesh #200.

Among the composition described in Tables 5 and 6, a composition of the G pigment dispersion 3 was as follows:

| | |
|---|---|
| C.I.Pigment.Green 36 | 18 parts |
| Polymer (random copolymer of benzyl | 12 parts |
| methacrylate/methacrylic acid = 72/28 mole ratio, | |
| weight average molecular weight 37,000) | |
| Cyclohexanone | 35 parts |
| Propylene glycol monomethyl ether acetate | 35 parts |
| Y pigment dispersion 3 (trade name: CF | |
| Yellow EX3393, manufactured by Mikuni Color Ltd.) | |

The colored photosensitive resin composition B3 was obtained by first weighing a B pigment dispersion 4, a B pigment dispersion 5, and propylene glycol monomethyl ether acetate at amounts described in Table 5, mixing them at a temperature of 24° C. (+2° C.), stirring the mixture at 150 rpm for 10 minutes, then, weighing methyl ethyl ketone, a binder 6, a DPHA solution, 2-trichloromethyl-5-(p-styrylmethyl)-1,3,4-oxadiazole, 2, 4-bis(trichloromethyl)-6-[4-(N,N-diethoxycarbonylmethyl)-3-bromophenyl]-s-triazine, and phenothiazine at amounts described in Table 5, adding them in this order at a temperature of 25° C. (±2° C.), stirring the mixture at a temperature of 40° C. (±2° C.) and 150 rpm for 30 minutes, further, weighing a surfactant 2 at an amount described in Table 5, adding it at a temperature of 24° C. (±2° C.), stirring the mixture at 30 rpm for 5 minutes, and filtering this with a nylon mesh #200.

Among the composition described in Tables 5 and 6,

B pigment dispersion 4 (trade name: CF Blue EX3357, manufactured by Mikuni Color Ltd.)
B pigment dispersion 5 (trade name: CF Blue EX3383, manufactured by Mikuni Color Ltd.) a composition of the binder 6 was as follows:

| | |
|---|---|
| Random copolymer of benzyl methacrylate/methacrylic | 27 parts |
| acid/methyl methacrylate = 36/22/42 | |
| mole, weight average molecular weight 30,000 | |
| Propylene glycol monomethyl ether acetate | 73 parts |

### Examples 10 to 16 and Comparative Examples 3 to 6

According to the same manner that of Example 9 except that compositions of the colored photosensitive resin compositions R3, G3 and B3 used in Example 9 were changed to compositions of colored photosensitive resin compositions R4, G4 and B4 described in the above Table 5, respectively, a motor mill M-50 (manufactured by Aiger), and zirconia beads having a diameter of 0.65 mm were used, and the material was dispersed at a circumferential rate of 9 m/s to prepare pigment dispersion compositions, objective color filters were manufactured. A number average particle diameter of a pigment and dispersing time of a composition at this time are shown in Tables 8 and 9.

Among the composition described in Tables 5 and 6, a composition of the G pigment dispersion 4 was as follows:

| | |
|---|---|
| C.I.Pigment.Green 36 | 14 parts |
| Polymer (random copolymer of benzyl | 23 parts |
| methacrylate/methacrylic acid = 72/28 mole ratio, | |
| weight average molecular weight 37,000) | |
| N,N′-bis-(3-diethylaminopropyl)-5-[4-[2-oxo- | 1.4 parts |
| 1-(2-oxo-2,3-dihydro-1H-benzimidazol-5-yl | |
| carbamoyl)-propylazo]-benzoylamino]-isophthalamide | |
| Propylene glycol monomethyl ether acetate | 61.6 parts |

a composition of the Y pigment dispersion 4 was as follows:

| | | |
|---|---|---|
| C.I.Pigment.Yellow 150 | 15 | parts |
| Polymer (random copolymer of benzy | 9 | parts |
| methacrylate/methacrylic acid = 72/28 mole ratio, weight | | |
| average molecular weight 37,000) | | |
| N,N′-bis-(3-diethylaminopropyl)-5-[4-[2-oxo- | 1.5 | parts |
| 1-(2-oxo-2,3-dihydro-1H-benzimidazol-5-yl | | |
| carbamoyl)-propylazo]-benzoylamino]-isophthalamide | | |
| Propylene glycol monomethyl ether acetate | 74.5 | parts |

a composition of the B pigment dispersion 6 was as follows:

| | | |
|---|---|---|
| C.I.Pigment.Blue 15:6 | 11.28 | parts |
| C.I.Pigment.Violet 23 | 0.72 | part |
| EFKA-745 (manufactured by EFKA ADDITIVES B.V.) | 0.6 | part |
| Disparon DA-725 (manufactured by Kusumoto Chemicals, | 0.75 | parts |
| Ltd.) | | |
| Propylene glycol monomethyl ether acetate | 86.65 | parts |

### Manufacturing of Liquid Crystal Display Devise (Examples 9 to 16, 25 and 27, Comparative Examples 3 to 6)

(PVA display mode) (Without rib)

An ITO film was formed on the color filter layer manufactured above (in Example 27, a spacer was formed thereon)

Patterning for a PVA display mode was formed of a transparent electrode of the ITO (Indium Tin Oxide) and a counter substrate (TFT substrate). Further, an oriented film of polyimide was provided thereon. A sealing material was coated on a position corresponding to an external frame of a black matrix provided at a periphery of a pixel group of a color filter, to form a sealing part having a width of 0.5 mm and a height of 40 μm, a liquid of crystal for a PVA display mode was added dropwise, and opposite glass substrates were laminated under reduced pressure (not higher than 13 Pa). A pressure was returned to a normal pressure, and a load was applied to control a cell thickness to 4 μm. In this state, by using a metal halide lamp, and cutting with ultraviolet of less than 340 nm, light was irradiated under the nitrogen atmosphere so that an accumulated light amount at 340 to 390 nm became a light amount corresponding to 3,000 mJ/cm², to optically cure the sealing material. A polarizing plate HLC2-2518 manufactured by Sanritz Corporation was applied to both sides of this liquid crystal cell. Then, using FR1112H (chip-type LED manufactured by Stanley Electric Co., Ltd.) as red (R) LED, DG1112H (chip-type LED manufactured by Stanley Electric Co., Ltd.) as green (G) LED, and DB1112H (chip-type LED manufactured by Stanley Electric Co., Ltd.) as blue (B) LED, a sidelight type backlight was constructed, and this was disposed on a rear side of the liquid crystal cell with a polarizing plate impaired, to obtain a liquid crystal display device.

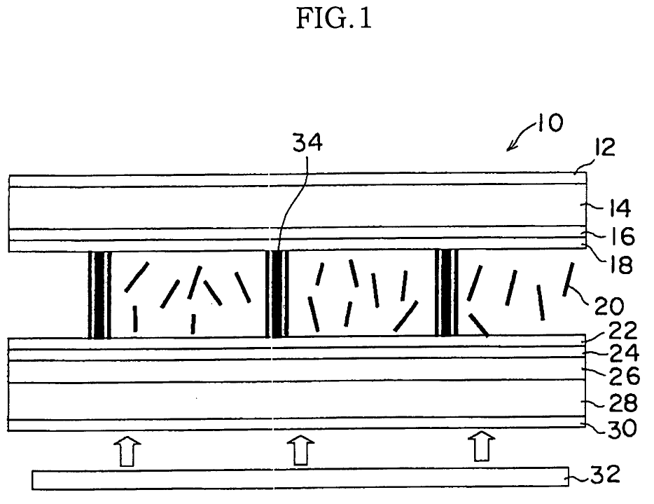

The above liquid crystal display device is shown in FIG. 1.

FIG. 1 is a schematic cross-sectional view showing the liquid crystal display device 10 of the above Example. In FIG. 1, 12 is a polarizing plate, 14 is a substrate, 16 is an ITO film, 18 is an oriented film, 20 is a liquid crystal, 22 is an oriented film, 24 is an ITO film, 26 is a color filter, 28 is a substrate, 30 is a polarizing plate, 32 is a backlight, and 34 is a spacer.

### Examples 17 and 26

### Manufacturing of Color Filter by Transference

### —Manufacturing of Photosensitive Resin Transferring Material—

Using a slit-like nozzle, a coating solution for a thermoplastic resin layer consisting of the following formulation H2 was coated on a polyethylene terephthalate film provisional support having a thickness of 75 μm, and dried. Then a coating solution for an intermediate layer consisting of the following formulation P2 was coated, and dried. Further, a colored photosensitive resin composition K2 consisting of a composition described in the above Table 5 was coated, and dried to provide a thermoplastic resin layer having a dry film thickness of 14.6 μm, an intermediate layer having a dry film thickness of 1.6 μm, and a photosensitive resin layer of 2.4 μm on the provisional support, and a protecting film (polypropylene film having thickness of 12 μm) was adhered thereto.

Thus, a photosensitive resin transferring material in which the provisional support, the thermoplastic resin layer, the intermediate layer (oxygen shielding film) and the black (K) photosensitive resin layer were integrated was manufactured, and the sample was named as photosensitive resin transferring material K2.

Coating solution for thermoplastic resin layer: formulation H2

| | |
|---|---|
| Methanol | 11.1 parts |
| Propylene glycol monomethyl ether acetate | 6.36 parts |
| Methyl ether ketone | 52.4 parts |
| Copolymer of methyl methacrylate/2-ethylhexyl acrylate/benzyl methacrylate/methacrylic | 5.83 parts |
| acid (copolymerization compositional ratio (mole ratio) = 55/30/10/5, weight average | |
| molecular weight = 100,000, Tg ≈ 70° C.) | |
| Copolymer of styrene/acrylic acid (copolymerization compositional ratio (mole ratio) = 65/35, | 13.6 parts |
| weight average molecular weight = 10,000, Tg = 100° C.) | |
| Compound in which 2 equivalent of pentaethylene glycol monomethacrylate is | 9.1 parts |
| dehydration-condensed with bisphenol A (trade name: BPE-500 manufactured by | |
| Shin-Nakamura Chemical Co., Ltd.) | |
| Surfactant 2 (trade name: MEGAFACE F780F, manufactured by Dainippon Ink and | 0.54 parts |
| Chemicals, Incorporated) | |

Coating solution for intermediate layer: formulation P2

| | |
|---|---|
| PVA205 (polyvinyl alcohol, manufactured by Kuraray Co., Ltd., saponification degree = 88%, | 32.2 parts |
| polymerization degree 550) | |
| Polyvinylpyrrolidone (trade name: K-30, manufactured by BASF) | 14.9 parts |
| Distilled water | 524 parts |
| Methanol | 429 parts |

Then, according to the same manner as that described above expect that the colored photosensitive resin composition K2 used in manufacturing the photosensitive resin transferring material K2 was changed to the following colored photosensitive resin composition R5, G5 or B5 consisting of a composition described in the above Table 6, photosensitive resin transferring materials R5, G5 and B5 were manufactured.

### —Formation of Black (K) Image—

An alkali-free glass substrate was washed with a rotation brush having a nylon bristle while a glass detergent solution regulated at 25° C. was blown for 20 seconds, washed with a pure water shower, a silane coupling solution (N-β(aminoethyl)γ-aminopropyltrimethoxysilane 0.3% aqueous solution, trade name: KBM603, manufactured by Shin-Etsu Chemical Co., Ltd.) was blown for 20 seconds with a shower, and this was washed with a pure water shower. This substrate was heated at 100° C. for 2 minutes with a substrate pre-heating apparatus.

A protecting film for the photosensitive resin transferring material K2 was peeled, and this was laminated on the substrate heated at 100° C. for 2 minutes, using a laminator (manufactured by Hitachi Industries Co., Ltd. (Lamic Model II)) at a rubber roller temperature of 130° C., a linear pressure of 100 N/cm, and a conveying rate of 2.2 m/min.

After peeling of the protecting film, in the state where the substrate and a mask (quartz light exposing mask having image pattern) were stood vertical, a distance between a light exposing mask surface and the photosensitive resin layer was set to be 200 μm, and pattern light exposure was performed with a proximity-type light exposing machine having a ultrahigh pressure mercury lamp (manufactured by Hitachi Hi-Tech Electronics Engineering Co., Ltd.) at a light exposure amount of 70 mJ/cm².

Then, this was shower-developed with a triethanolamine-based developer (containing 2.5% triethanolamine, containing nonionic surfactant, containing polypropylene-based anti-foaming agent, trade name: T-PD1, manufactured by Fuji Photo Film Co., Ltd.) at 30° C. for 50 seconds al: a flat nozzle pressure of 0.04 MPa, and the thermoplastic resin layer and an oxygen shielding layer were removed.

Subsequently, this was shower-developed at 29° C. for 30 seconds with a cone-type nozzle at a pressure of 0.15 MPa using a sodium carbonate-based developer (containing 0.06 mole/liter sodium bicarbonate, sodium carbonate having the same concentration, 1% sodium dibutylnaphthalenesulfonate, anionic surfactant, anti-foaming agent, and stabilizer, trade name: T-CD1, manufactured by Fuji Photo Film Co., Ltd.), to develop the photosensitive resin layer to obtain a patterning pixel.

Subsequently, the residue was removed with a shower and a rotation brush having a nylon bristle at 33° C. for 20 seconds with a cone-type nozzle at a pressure of 0.02 MPa using a detergent (containing phosphate, silicate, nonionic surfactant, anti-foaming agent, and stabilizer, trade name: T-SD1, manufactured by Fuji Photo Film Co., Ltd.), to obtain a black (K) image. Thereafter, further, the substrate was post-exposed with light at 500 mJ/cm² using an ultrahigh pressure mercury lamp from a side of the resin layer, and heat-treated at 220° C. for 15 minutes.

This substrate on which the K image was formed was washed again with a brush as described above, washed with a pure water shower, and heated at 100° C. for 2 minutes with a substrate pre-heating apparatus without using a silane coupling solution.

### —Formation of Red (R) Pixel—

According to the same step as that of the photosensitive resin transferring material K2, and using the photosensitive resin transferring material R5, a red (R) pixel, and a red (R) pattern of a 28×28 μm square were formed on the substrate on which the black (K) image was formed. A light exposure amount was 40 mJ/cm², development with a sodium carbonate-based developer was performed at 35° C. for 35 seconds, and heat treatment was performed at 220° C. for 15 minutes.

A film thickness of the photosensitive resin layer R5 was 2.0 μm, and coating amounts of pigments C.I.Pigment•Red 254 and C.I.Pigment•Red 177 were 0.88 g/m² and 0.22 g/m², respectively.

This substrate on which the R pixel was formed was washed again with a brush as described above, washed with a pure water shower, and heated at 100° C. for 2 minutes with a substrate pre-heating apparatus without using a silane coupling solution.

### —Formation of Green (G) Pixel—

According to the same step as that of the photosensitive resin transferring material K2, and using the photosensitive resin transferring material G5, a green (G) pixel, and a green (G) pattern were formed on the substrate on which the red (R) pixel was formed, so as to cover the whole red (R) pattern on the red (R) pattern. A light exposure amount was 40 mJ/cm², development with a sodium carbonate-based developer was performed at 34° C. for 45 seconds, and heat treatment was performed at 220° C. for 15 minutes.

A film thickness of the photosensitive resin layer G5 was 2.0 μm, and coating amounts of pigments C.I.Pigment•Green 36 and C.I.Pigment•Yellow 150 were 1.12 g/m² and 0.48 g/m², respectively.

The substrate on which the R and G pixels were formed was washed again with a brush as described above, washed with a pure water shower, and heated at 100° C. for 2 minutes with a substrate pre-heating apparatus without using a silane coupling solution.

### —Formation of Blue (B) Pixel—

According to the same step as that of the photosensitive resin transferring material K2, and using the photosensitive resin transferring material B5, a blue (B) pixel was obtained on the substrate on which the red (R) pixel and the green (G) pixel were formed. A light exposing amount was 30 mJ/cm², and development with a sodium carbonate-based developer was performed at 36° C. for 40 seconds.

A film thickness of the photosensitive resin layer B5 was 2.0 μm, and coating amounts of pigments C.I.Pigment•Blue 1:5:6 and C.I.Pigment•Violet 23 were 0.63 g/m² and 0.67 g/m², respectively.

This substrate on which the R, G and B pixels and the K image were formed was baked at 240° C. for 50 minutes to manufacture an objective color filter.

A process for preparing the colored photosensitive resin compositions G5 and B5 described in Table 6 is according to the process for preparing colored photosensitive resin compositions G3 and B3.

The colored photosensitive resin composition R5 was obtained by first weighing a R pigment dispersion 3, a R pigment dispersion 4, and propylene glycol monomethyl ether acetate at amounts described in Table 6, mixing them at a temperature of 24° C. (±2° C.), stirring the mixture at 150 rpm for 10 minutes, then, weighing methyl ethyl ketone, a binder 5, a DPHA solution, 2-trichloromethyl-5-(p-styrylmethyl)-1,3,4-oxadiazole, 2,4-bis(trichloromethyl)-6-[4-(N,N-diethoxycarbonylmethyl)-3-bromophenyl]-s-triazine, and phenothiazine at amounts described in Table 6, adding them in this order at a temperature of 24° C. (+2° C.), stirring them at 150 rpm for 10 minutes, then weighing ED152 at an amount described in Table 6, mixing them at a temperature of 24° C. (+2° C.), stirring the mixture at 150 rpm for 20 minutes, further, weighing a surfactant 2 at an amount described in Table 6, adding it at a temperature of 24° C. (±2° C.), stirring the mixture at 30 rpm for 30 minutes, and filtering this with a nylon mesh #200.

*ED152 is a phosphate ester-based special active agent (trade name: HIPLAAD ED152, manufactured by Kusumoto Chemicals, Ltd.).

### Examples 18 to 24, and 26, and Comparative Examples 7 to 10

According to the same manner as that of Example 17 except that compositions of colored photosensitive resin compositions R5, G5 and B5 used in Example 17 were changed to compositions of colored photosensitive resin compositions R6, G6 and B6 described in the above Table 6, respectively, a motor mill M-50 (manufactured by Aiger), and zirconia beads having a diameter of 0.65 mm were used, and the material was dispersed at a circumferential rate of 9 m/s to prepare a pigment dispersion composition, an objective color filter was obtained. A number average particle diameter of a pigment and a dispersing time of a composition at this time are shown in Tables 8 and 9.

### —Manufacturing and Assessment of Liquid Crystal Display Device (Examples 18 to 24, and 26, Comparative Examples 7 to 10)—

An ITO film was formed on each of color filter layers manufactured above (in Example 28, a spacer was formed thereon).

### (Manufacturing of Photosensitive Transferring Material for Projection)

A coating solution consisting of the aforementioned formulation H2 was coated on a polyethylene terephthalate film provisional support having a thickness of 75 μm, and dried to provide a thermoplastic resin layer having a dry film thickness of 15 μm.

Then, a coating solution consisting of the aforementioned formulation P2 was coated on the thermoplastic resin layer, and dried to provide an intermediate layer having a dry film thickness of 1.6 μm.

A coating solution for a projection photosensitive resin layer consisting of the following formulation A was coated on the intermediate layer, and dried to provide a photosensitive resin layer of projection for liquid crystal orientation control having a dry film thickness of 2.0 μm.

Coating solution for projection photosensitive resin layer: formulation A

| | |
|---|---|
| Positive-type resist solution | 53.3 parts |
| (trade name: FH-2413F, manufactured by Fuji Film | |
| Electromaterials) | |
| Methyl ethyl ketone | 46.7 parts |
| Surfactant 2 | 0.04 part |

Further, a polypropylene film having a thickness of 12 μm as a cover film was applied to the photosensitive resin layer surface, to manufacture a photosensitive transferring material for projection in which the thermoplastic resin layer, the intermediate layer, the photosensitive resin layer, and the cover film were laminated in this order on the provisional support.

### (Formation of Projection)

A cover film was peeled from the photosensitive transferring material for projection obtained above, a surface of the photosensitive resin layer and a surface on a side on which an ITO film of the color filter side substrate was provided were overlaid, and laminated under conditions of a linear pressure of 100 N/cm², a temperature of 130° C. and a conveying rate of 2.2 m/min using a laminator (manufactured by Hitachi Industries Co., Ltd. (Lamic Model II)). Thereafter, only a provisional support of the transferring material was peeled and removed at a boundary between the thermoplastic resin layer. In this state, the photosensitive resin layer, the intermediate layer, and the thermoplastic resin layer were laminated in this order on a color filter side substrate.

Then, a proximity light exposing machine was arranged above the thermoplastic resin layer which is an outermost layer, so that a photomask was situated at a distance from a surface of the photosensitive resin layer became 100 μm, and proximity light exposure was performed with a ultrahigh pressure mercury lamp at an irradiation energy of 70 mJ/cm² via the photomask. Thereafter, a 1% aqueous triethanolamine solution was sprayed to a substrate at 30° C. for 30 seconds with a shower-type developing apparatus to dissolve and remove the thermoplastic resin layer and the intermediate layer. At this stage, the photosensitive resin layer was not substantially developed.

Subsequently, development was performed while 0.085 mol/L sodium carbonate, 0.085 mmol/L sodium bicarbonate and a 1% aqueous sodium dibutylnaphthalenesulfonate solution were sprayed to the substrate at 33° C. for 30 seconds with a shower-type developing apparatus, to develop and remove an unnecessary part (uncured part) of the photosensitive resin layer. And, a projection consisting of a photosensitive resin layer patterned into a desired shape was formed on a base of spacer formed by laminating the red (R) and green (G) patterns, and on a color film side substrate. Then, the filter side substrate on which the projection was formed was baked at 240° C. for 50 minutes, thereby, a spacer having a height of 3.4 μm from a green (G) pixel was formed on a base of a spacer formed by laminating the red (R) and green (G), and a projection for liquid crystal orientation control having a height of 10.5 μm, and a longitudinal cross-section shape of a semicircle was formed on a color filter side substrate.

Further, according to the same manner as that of Example 9 except that a backlight was changed to a three wavelength cold cathode tube light source (CCFL: Cold Cathode Fluorescent Lamp, manufactured by Samson Electronics Company Limited) relative to the color filter side substrate obtained above, the 20 inch liquid crystal display device of the invention was manufactured, provided that in Example 26, HC2-6018 was used as a polarizing plate and, in Comparative Examples 7 to 10, the same polarizing plates as those of Comparative Examples 3 to 6 were used, respectively.

An oriented film of polyimide was disposed on the color filter substrate on which KRGB, the spacer and the projection for liquid crystal orientation control were provided. A sealing agent of an epoxy resin containing spacer particles was printed at a position corresponding to an external frame of a black matrix provided at a periphery of a pixel group of the cooler filter, and the color filter substrate and a counter substrate (TFT substrate) were laminated to each other at a pressure of 10 kg/cm². Then, laminated glass substrates were heat-treated at 150° C. for 90 minutes to cure the sealing agent, to obtain a laminate of two glass substrates. This glass substrate laminate was degassed under vacuum, thereafter, a pressure was returned to an atmospheric pressure, and a liquid crystal was injected into a gap between two glass substrates. After completion of injection, an injection port part was sealed using an adhesive by irradiating with ultraviolet-ray, to obtain a liquid crystal cell.

A backlight of CCFL was constructed on both sides of this liquid crystal cell, and disposed on a rear side of the liquid crystal cell with the polarizing plate imparted, to obtain a liquid crystal display device.

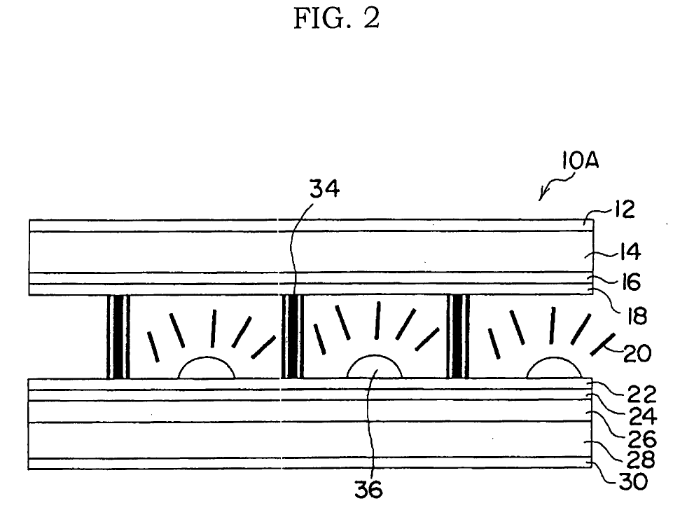

The above liquid crystal display device is shown in FIG. 2. FIG. 2 is a schematic cross-sectional view showing the liquid crystal display device 10A relating to the above Example. In FIG. 2, the same symbols are added to the same components as those of FIG. 1. 12 is a polarizing plate, 14 is a substrate, 16 is an ITO film, 18 is an oriented film, 20 is a liquid crystal, 22 is an oriented film, 24 is an ITO film, 26 is a color filter, 28 is a substrate, 30 is a polarizing plate, 34 is a spacer, and 36 is a projection.

### Example 27

### Liquid Resistor

According to the same manner as that of Example 9 except that a spacer was not formed by laminating respective pixels, a color filter was formed.

### [Manufacturing of Liquid Crystal Display Device]

After a transparent electrode film was formed on the color filter manufactured in Example 27 by sputtering of ITO, a spacer was formed by the following method.

### (Preparation of Photosensitive Resin Composition S for Spacer)

A photosensitive resin composition S for a spacer consisting of 34.0 parts by mass of a methacrylic acid/allyl methacrylate copolymer (mole ratio=20/80, weight average molecular weight=40,000), 1.8 parts by mass of dipentaerythritol hexaacrylate, 7.1 parts by mass of a suspension of 30 mass % silica sol in methyl isobutyl ketone (trade name: MIBK-ST, manufactured by Nissan Chemical Industries, Ltd.), 0.001 part by mass of phenothiazine, 0.17 part by mass of 2,4-bis-(trichloromethyl)-6-[4-(N,N-diethoxycarbonylmethylamino)-3-bromophenyl]-s-triazine, 0.02 part by mass of VictoriaPure Blue BOHM, 0.01 part by mass of a surfactant 2, 7.4 parts by mass of ethyl methyl ketone, 8.6 parts by mass of 1-methoxy-2-propyl acetate, and 0.5 part by mass of methanol was prepared according to the process for preparing the colored photosensitive resin composition R3.

### (Manufacturing of Spacer)

Then, according to the same step as that of a method of forming a black (K) image of Example 9, and using the manufactured photosensitive resin transferring material S for a spacer, a spacer was formed on the color filter substrate on which ITO was sputtered, provided that a light exposure amount was 40 mJ/cm², development with a KOH-based developer diluted 100-fold used in Example 9 was performed at 23° C. for 80 seconds, and heat treatment was performed at 230° C. for 30 minutes.

Further, according to the same manner as that of Example 9, a liquid crystal display device was manufactured with respect to the color filter side substrate obtained above.

As compared with the liquid crystal display device using a color filter of Example 9, display property was good similarly, but the device of Example 9, which was manufactured by fewer manufacturing step numbers al a low cost is more preferable.

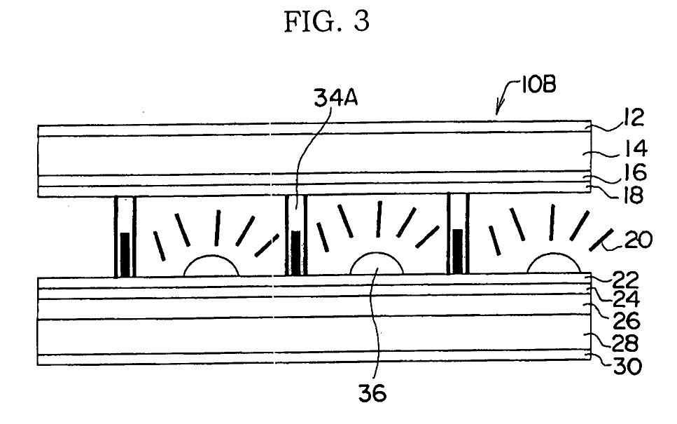

The above liquid crystal display device is shown in FIG. 3. FIG. 3 is a schematic cross-sectional view showing the liquid crystal display device 10B of the above Example 27. In FIG. 3, the same symbols added to the same components as those of FIG. 2. 12 is a polarizing plate, 14 is a substrate, 16 is an ITO film, 18 is an oriented film, 20 is a liquid crystal, 22 is an oriented film, 24 is an ITO film, 26 is a color filter, 28 is a substrate, 30 is a polarizing plate, 34A is a spacer from a colored photosensitive resin composition, and 36 is a projection.

### Example 28

### Transference

According to the same manner as that of Example 17 except that a base of a spacer is not formed by laminating respective pixels, a color filter was formed.

### [Manufacturing of Liquid Crystal Display Device]

A transparent electrode film was formed on the color filter manufactured in the above Example 28 by sputtering of ITO.

Subsequently, according to the same manner as that of Example 27, a photosensitive resin composition S for a spacer was prepared and, according to the same manner as that of the photosensitive resin transferring material K2, a photosensitive resin transferring material S was made, and a spacer was obtained on the color filter substrate using the photosensitive transferring material S, provided that a light exposure amount was 40 mJ/cm², development with a KOH-based developer diluted 100-fold used in Example 9 was performed at 36° C. for 40 seconds, and heat treatment was performed at 230° C. for 30 minutes.

Thereafter, according to the same manner as that of Example 17, a projection for liquid crystal orientation control was formed and, according to the same manner as that of Example 17, a liquid crystal display device was manufactured with respect to the color filter side substrate obtained above.

As compared with the liquid crystal display device using a color filter of Example 17, display property was good similarly, but the device of Example 17, which was manufactured by fewer manufacturing step numbers at a low cost is more preferable.

### [Assessment]

### —Measurement of Contrast—

A contrast of each colored pixel constituting the color filter obtained above was measured by the following measuring method, and a difference in contrasts of the respective colored pixels was calculated. Results are shown in Tables 8 and 9.

### —Measurement of Particle Diameter—

As a number average particle diameter of a pigment, a photograph image of pigment particles was taken using a transmission electron microscope (JEOL.Ltd., JEM-2010-electromicroscope), a diameter when the image is assumed to be a circle having the same area was adopted as a particle diameter, and this was measured regarding 100 particles, and an average was obtained.

### (Method of Measuring Contrast)

Using a three wavelength cold cathode tube light source as a backlight, a color filter was disposed between two polarizing plates (trade name: G1220DUN, manufactured by Nitto Denko Corporation), and a contrast was obtained by dividing a Y value of a chromaticity of light which passes when polarizing plates are arranged parallel by a Y value of a chromaticity of light which passes when polarizing plates are arranged at crossed nicol. For measuring a chromaticity, a color luminance meter (trade name: BM-5, manufactured by TOPCON) was used.

### —Measurement of Black Display—

Liquid crystal display devices using color filters manufactured in Examples 9 to 28, and Comparative Examples 3 to 10 were black-displayed, a chromaticity at this time was measured, an achromatic chromaticity was defined as (x,y,Y=0.333, 0.333, 0.08), and a color difference ΔE between this color was calculated. Results are shown in Tables 8 and 9. A chromaticity at a black display was measured by the following method. A backlight and polarizing plates were arranged using a backlight and polarizing plates used in a liquid crystal display device to be measured, so that two polarizing plates became at crossed nicol, the color filter was arranged between the polarizing plates, and a chromaticity of leaked light was measured using a color luminance meter (trade name: BM-5, manufactured by TOPCON). A color difference between an achromatic point is preferably 5 or less. When the difference exceeds 5, black display is colored and, therefore, this is not preferable.

### —Method of Assessing Vividness—

Vividness when red, green and blue solid colors were displayed at a background of black display of liquid crystal display devices using color filters manufactured in Examples 9 to 28, and Comparative Examples 3 to 10 was organoleptically assessed by 50 subjects. Vividness was assessed by five stages in an order of higher clearness, and an average was adopted as an assessment value. Results are shown in Tables 8 and 9. A indicates not lower than 4 and not higher than 5, B indicates not lower than 3 and less than 4, and C indicates less than 3.

### —Generic Assessment—

Generic assessment of display quality as a liquid crystal display device was performed according to criteria shown in the following Table 7. Results are shown in Tables 8 and 9.

TABLE 7

| Generic | Vividness | | |
|---|---|---|---|
| assessment criteria | A | B | C |

| | | | | |
|---|---|---|---|---|
| ΔE | Not higher than 4.5 | A | B | C |
| | 4.5 to 5.0 | B | B | C |
| | Not lower than 5.0 | C | C | C |

TABLE 8

| | | | | | | | | | |
|---|---|---|---|---|---|---|---|---|---|
| | | Number | | | | | Color | | |
| Colored | | average | | | | | difference | | |
| photosensitive | | particle | | | | Crossed | between | | |
| resin | Dispersing | diameter | | Contrast | Polarization | transmittance | achromatic | | Generic |
| composition | time [h] | [nm] | Contrast | difference | degree | [%] | point | Clearness | assessment |

| | | | | | | | | | |
|---|---|---|---|---|---|---|---|---|---|
| Example | R3, 5 | | 51 | 3402 | 91 | HLC2-2518 | 4.0 | A | A |
| 9, 17, 27, 28 | G3, 5 | | 57 | 3427 | | [Polarization degree] 99.991 | | | |
| | B3, 5 | | 55 | 3493 | | [Transmittance] 0.01% | | | |
| Example 10, 18 | R4, 6 | 27 | 52 | 3400 | 100 | | 4.0 | A | A |
| | G4, 6 | 28 | 57 | 3430 | | | | | |
| | B4, 6 | 27 | 54 | 3500 | | | | | |
| Example 11, 19 | R4, 6 | 21 | 60 | 3002 | 310 | | 4.6 | A | A |
| | G4, 6 | 22 | 70 | 3153 | | | | | |
| | B4, 6 | 23 | 64 | 3312 | | | | | |
| Example 12, 20 | R4, 6 | 12 | 82 | 2013 | 502 | | 4.8 | B | B |
| | G4, 6 | 13 | 88 | 2233 | | | | | |
| | B4, 6 | 11 | 87 | 2515 | | | | | |
| Example 13, 21 | R4, 6 | 12 | 76 | 2105 | 195 | | 4.1 | B | B |
| | G4, 6 | 13 | 91 | 2120 | | | | | |
| | B4, 6 | 11 | 90 | 2300 | | | | | |
| Example 14, 22 | R4, 6 | 23 | 59 | 3012 | 86 | | 4.0 | A | A |
| | G4, 6 | 22 | 73 | 3052 | | | | | |
| | B4, 6 | 22 | 71 | 3098 | | | | | |
| Example 15, 23 | R4, 6 | 23 | 56 | 3188 | 401 | | 4.7 | A | B |
| | G4, 6 | 23 | 58 | 3412 | | | | | |
| | B4, 6 | 23 | 52 | 3589 | | | | | |
| Example 16, 24 | R4, 6 | 28 | 54 | 3308 | 304 | | 4.6 | A | B |
| | G4, 6 | 29 | 59 | 3312 | | | | | |
| | B4, 6 | 29 | 51 | 3612 | | | | | |
| Example 25 | R3, 5 | | 51 | 3402 | 91 | UHLC2-5618 | 4.1 | B | B |
| | G3, 5 | | 57 | 3427 | | [Polarization degree] 99.975 | | | |
| | B3, 5 | | 55 | 3493 | | [Transmittance] 0.01% | | | |
| Example 26 | R3, 5 | | 51 | 3402 | 91 | HC2-6018 | 4.3 | B | B |
| | G3, 5 | | 57 | 3427 | | [Polarization degree] 99.952 | | | |
| | B3, 5 | | 55 | 3493 | | [Transmittance] 0.02% | | | |

TABLE 9

| | | | | | | | | | |
|---|---|---|---|---|---|---|---|---|---|
| | | Number | | | | | Color | | |
| Colored | | average | | | | | difference | | |
| photosensitive | | particle | | | | Crossed | between | | |
| resin | Dispersing | diameter | | Contrast | Polarization | transmittance | achromatic | | Generic |
| composition | time [h] | [nm] | Contrast | difference | degree | [%] | point | Clearness | assessment |

| | | | | | | | | | |
|---|---|---|---|---|---|---|---|---|---|
| Comparative | R4, 6 | 9 | 105 | 1350 | 430 | HLC2-2518 | 4.7 | C | C |
| Example 3, 7 | G4, 6 | 8 | 103 | 1702 | | [Polarization degree] 99.991 | | | |
| | B4, 6 | 9 | 110 | 1780 | | [Transmittance] 0.01% | | | |
| Comparative | R4, 6 | 12 | 81 | 2053 | 634 | | 5.5 | B | C |
| Example 4, 8 | G4, 6 | 14 | 89 | 2512 | | | | | |
| | B4, 6 | 12 | 89 | 2687 | | | | | |
| Comparative | R3, 5 | | 51 | 3402 | 91 | BLC2-5618 | 6.1 | C | C |
| Example 5, 9 | G3, 5 | | 57 | 3427 | | [Polarization degree] 99.819 | | | |
| | B3, 5 | | 55 | 3493 | | [Transmittance] 0.12% | | | |
| Comparative | R3, 5 | | 51 | 3402 | 91 | HC2-6118 | 5.6 | C | C |
| Example 6, 10 | G3, 5 | | 57 | 3427 | | [Polarization degree] 99.83 | | | |
| | B3, 5 | | 55 | 3493 | | [Transmittance] 0.06% | | | |

From Tables 8 and 9, the liquid crystal display device of the invention provided with a polarizing plate in which the contrast is not lower than 2000, the difference between the contrast of the colored pixel having the lowest contrast and the contrast of the colored pixel having the highest contrast among colored pixels of three colors is not more than 600, a polarization degree is not lower than 99.95, and an crossed transmittance at 400 nm is not higher than 0.05%, has a high contrast of each pixel, displays a vivid image, is balanced in contrasts of respective pixels of RGB, and is excellent in black display property.

On the other hand, liquid crystal display devices of Comparative Examples 3 and 7, provided with a color filter in which the contrast of each colored pixel is less than 2000, has a low contrast of each pixel, and exhibits an image lacking vividness, and liquid crystal display devices of Comparative Examples 4 and 8, provided with a color filter in which the difference between the contrast of the colored pixel having the lowest contrast and the contrast of the colored pixel having the highest contrast among colored pixels of three colors exceeds 600, is not balanced in contrasts of respective pixels of RGB, has display shifted to a reddish direction due to a low contrast of a red colored pixel, and is inferior in black display property. In addition, even when a color filter having a high contrast, and a small difference in contrasts of respective colored pixels is used, liquid crystal display devices using a polarizing plate described in Comparative Examples 5, 6, 9 and 10 has a large color difference from an achromatic point, is low in black display property, and cannot provide a vivid image.

### INDUSTRIAL APPLICABILITY

According to the invention, a color filter can be provided, which has a high contrast ratio and, in particular, even when used in a large screen liquid crystal display device such as a display for a notebook computer or a television monitor, can realize sufficient color reproductivity. In addition, by using the color filter in a liquid crystal display device, color image display can be realized, which is vivid, has high color purity, and has high black display quality.

In addition, according to the invention, by a combination of a pixel having a high contrast and a polarizing plate having a high contrast, a liquid crystal display device which has a high contrast, displays a vivid image, is balanced in terms of the contrast of the respective pixels of RGB, and is excellent in black display property, can be provided.

1. A color filter comprising colored pixels of two or more colors, wherein each of the colored pixels contains at least pigment particles, the contrast of each of the colored pixels is not lower than 2000, and the difference between the contrast of a colored pixel having the lowest contrast and the contrast of a colored pixel having the highest contrast among the colored pixels of two or more colors is rot more than 600.

2. The color filter of claim 1, wherein the number average particle diameter of the pigment particles is 0.001 to 0.1 μm.

3. The color filter of claim 1, wherein at least one color of the colored pixels contains C.I.Pigment•Red 254.

4. The color filter of claim 1, wherein at least one color of the colored pixels contains C.I.Pigment•Green 36.

5. The color filter of claim 1, wherein at least one color of the colored pixels contains C.I.Pigment•Blue 15:6.

6. A process for manufacturing a color filter as defined in claim 1, the process comprising: forming a resin layer from a colored photosensitive resin composition containing (1) an alkali-soluble resin, (2) a monomer or an oligomer, (3) a photopolymerization initiator or a photopolymerization initiator system, and (4) pigment particles.

7. The process for manufacturing a color filter of claim 6, wherein the forming of the resin layer comprises coating the colored photosensitive resin composition by using a slit-like nozzle.

8. The process for manufacturing a color filter of claim 6, wherein the forming of the resin layer comprises laminating a resin transferring material in which a resin layer of a colored photosensitive resin composition is provided on a provisional support, on a substrate by using a laminator.

9. A liquid crystal display device, which comprises a color filter as defined in claim 1.

10. A liquid crystal display device comprising: a backlight, a polarizing plate, at least two substrates, a liquid crystal layer supported by the substrates, an electrode provided on at least one part of the substrates, and a color filter layer provided on at least one part of the substrates,
wherein the color filter layer is a color filter as defined in claim 1, and
the polarizing plate has a polarization degree of not lower than 99.95, and an crossed transmittance at 400 nm of not higher than 0.05%.

11. The liquid crystal display device of claim 10, wherein the number average particle diameter of the pigment particles is 0.001 to 0.1 μm.

12. The liquid crystal display device of claim 10, wherein at least one color of the colored pixels contains C.I.Pigment•Red 254.

13. The liquid crystal display device of claim 10, wherein at least one color of the colored pixels contains C.I.Pigment•Green 36.

14. The liquid crystal display device of claim 10, wherein at least one color of the colored pixels contains C.I.Pigment•Blue 15:6.
